(19) United States
(12) Patent Application Publication
(10) Pub. No.: US 2015/0175457 A1
(43) Pub. Date: Jun. 25, 2015

(54) TREATMENT OF WASTE WATER

(71) Applicant: THE COUNCIL FOR SCIENTIFIC AND INDUSTRIAL RESEARCH (CSIR), Pretoria (ZA)

(72) Inventors: Paul Johan Oberholster, Stellenbosch (ZA); Po-Hsun Cheng, Strand (ZA)

(21) Appl. No.: 14/576,000

(22) Filed: Dec. 18, 2014

(30) Foreign Application Priority Data
Dec. 19, 2013 (ZA) 2013/09637

(51) Int. Cl. C02F 3/32

(52) U.S. Cl. CPC C02F 3/322; C02F 2103/00

(57) ABSTRACT

A biological process for treating waste water includes introducing an algal component into the waste water. The algal component comprises Chlorella prototheocoides or a combination of Chlorella prototheocoides and Chlorella vulgaris. While maintaining passive conditions in the waste water, the algal component is allowed to extract at least one nutrient from the waste water, thereby to phycoremediate the waste water.

THIS INVENTION relates to the treatment of waste water. It relates in particular to a biological process for treating waste water in the form of sewage, particularly domestic sewage, for removal therefrom of nutrients, particularly nitrogen and phosphorous.

Phycoremediation is the use of algae for the removal of pollutants, such as nutrients and xenobiotics, from waste water and other resources. Of late, much effort has been made to apply intensive microalgal cultures to perform biological treatment of waste water. The underlying assumption is that the microalgae will transform some of the contaminants, i.e. infectious pathogens, into non-hazardous materials by means of bacterial destruction, enabling the treated waste water to be reused or safely discharged.

As microalgae assimilate carbon dioxide as a carbon source, they can grow photoautotrophically without the addition of an organic carbon source. In waste water treatment plants, unicellular green algae such as Chlorella sp. and Scenedesmus sp. have been widely used to colonise waste water ponds naturally and have fast growth rates and high nutrient removal capabilities.

Phycoremediation offers a low-cost and effective approach for removing excess nutrients and other contaminants in tertiary waste water treatment, while producing potentially valuable biomass, because of a high capacity for inorganic nutrient uptake. Microalgae have the potential to be used to remove various pollutants.

Using microalgae in continuous waste water treatment processes would be of great advantage, because most industries are in urgent need of implementing cost-effective continuous treatment processes. Algal species are relatively easy to grow, adapt and manipulate within a laboratory setting and appear to be ideal organisms for use in waste water remediation. In addition, phycoremediation has advantages over other conventional physico-chemical methods, such as ion-exchange, reverse osmosis, dialysis and electro-dialysis, membrane separation, activated carbon adsorption, and chemical reduction or oxidation, such as reduced cost due to its lower energy input and better nutrient removal efficiency as well as the low cost of its implementation and maintenance by low skill operators.

It is thus an object of this invention to provide a biological process for treating waste water, such as domestic sewage, whereby nutrients such as nitrogen and phosphorus can be extracted effectively from the waste water, by means of phycoremediation.

Thus, according to the invention, there is provided a biological process for treating waste water, which process includes

introducing an algal component into the waste water, wherein the algal component comprises Chlorella prototheocoides or a combination of Chlorella prototheocoides and Chlorella vulgaris; and

while maintaining passive conditions in the waste water, allowing the algal component to extract at least one nutrient from the waste water, thereby to phycoremediate the waste water.

The process may be a continuous process.

The waste water may be sewage, particularly domestic sewage. The sewage may be phycoremediated by removing nutrients such as magnesium, calcium, sulphur, carbon, cations, and, in particular, phosphorus and nitrogen therefrom by means of biosorption.

The algal component may be introduced into the waste water downstream of at least one other water treatment stage. In particular, the other water treatment stage may be a primary treatment stage; the process may then include first subjecting the sewage to primary treatment, in the primary treatment stage, to remove metals present therein.

The primary treatment stage may comprise a first pond. The primary treatment hence comprises passing the sewage through the first pond. The first pond may be a deep pond e.g. having a depth of 2-5 metres.

The effluent from the first pond may be subjected to secondary treatment to reduce the ammonia loading of the sewage. The secondary treatment may comprise passing the first pond effluent into a second pond, where digestion of organic material in the effluent takes place. If desired, the algal component may be introduced into the second pond.

The effluent from the second pond may be subjected to the treatment thereof, i.e. tertiary treatment, with the algal component in accordance with the invention. The tertiary treatment may thus be effected in a third pond, which may be a shallow pond, typically 0.5 to 1 m deep. Thus, the third pond provides a body of water comprising the second pond effluent, and in which nutrient removal from the sewage is effected by means of phycoremediation and while maintaining passive conditions in the third pond.

Sufficient of the algal component is introduced into the third pond initially so that the proportion of algal component cells, i.e. cultured cells, to other natural occurring algal cells, in the waste water is in a ratio of about 1 (cultured algal cell):1000 (natural occurring algal cells).

When the algal component comprises the combination of Chlorella prototheocoides and Chlorella vulgaris, the cellular ratio of the two algal species may be about 1:1.

The waste water residence time in the third pond will naturally be sufficient for a desired algal biomass, which will give a desired degree of nutrient removal from the waste water by means of phycoremediation, to be achieved. Thus, the residence time may be as short as 3 days; however, a residence time of at least 7 days is preferred.

Sufficient of the algal component may be used so that the total concentration of the algal combination in the waste water may start at 10 000 cells/ml. The final cell counts may be as high as 18 600-474 000 cells/ml/day for C. prototheocoides, and 213 000-322 000 cells/ml/day for the algal combination.

As hereinbefore described, passive treatment conditions are maintained in the third pond. The process is thus characterized thereby that no mechanical agitation or aeration is effected in the third or tertiary pond, while nevertheless achieving a desired degree of phycoremediation of the waste water. The entire process may be a passive treatment process, i.e. no mechanical agitation or aeration may be effected in any of the ponds.

Effluent from the third pond may be subjected to further treatment for algal removal i.e. to control algal proliferation. This may be effected in a fourth pond, in which the effluent is subjected to algae removal by means of zooplankton, such as Daphnia sp. However, it will be appreciated that, instead, other different taxons of zooplankton or filter feeder can be used.

The zooplankton may typically be initially introduced into the fourth pond at a rate of 6090 cells/ml/daphnia/day to 82727 cells/ml/daphnia/day for C. vulgaris algae; 7818 cells/ml/daphnia/day to 42181 cells/ml/daphnia/day for C. protheocoides algae, and 184545 combined algae cells/ml/daphnia/day to 283636 combined algae cells/ml/daphnia/day, typically about 55 385 algal cells/ml/daphnia/day. The waste water residence time in the fourth pond will be sufficient to achieve a desired degree of algal removal and may be in the region of 9 to 15 days, typically about 11 days.

The first, second, third and fourth ponds may form part of a rural waste water treatment process, with the ponds hence constituting rural waste water treatment ponds.

The invention will now be described in more detail with reference to the following non-limiting example and the accompanying drawings.

In the drawings,

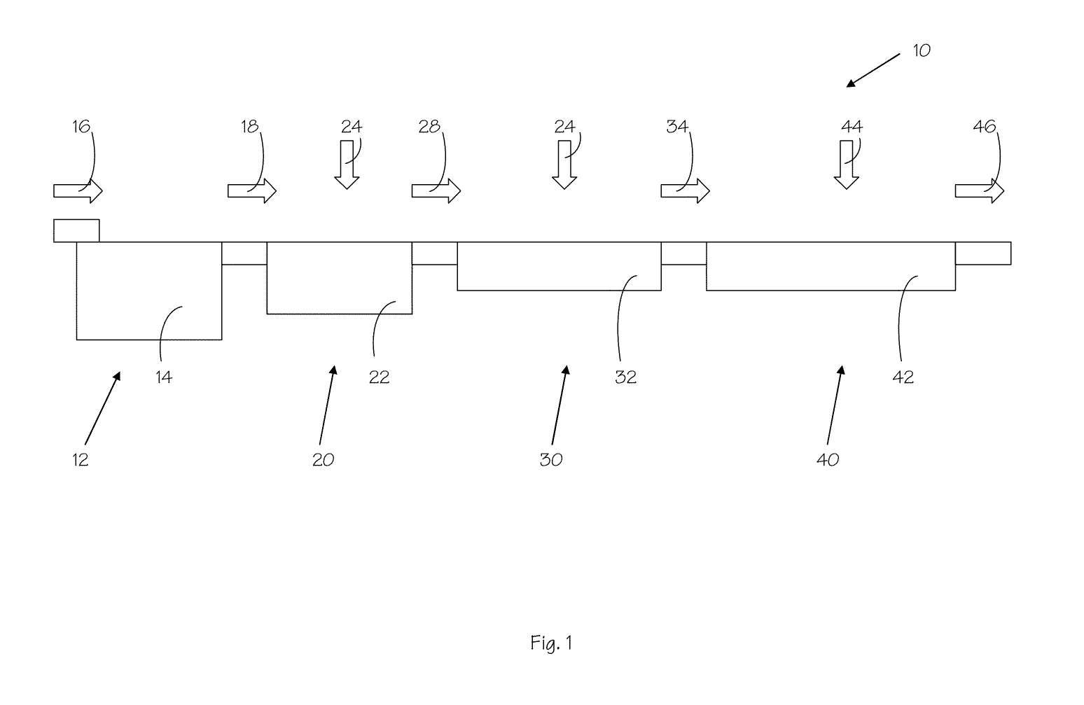

FIG. 1 shows, in simplified block diagram form, a biological process for treating domestic sewage, in accordance with the invention;

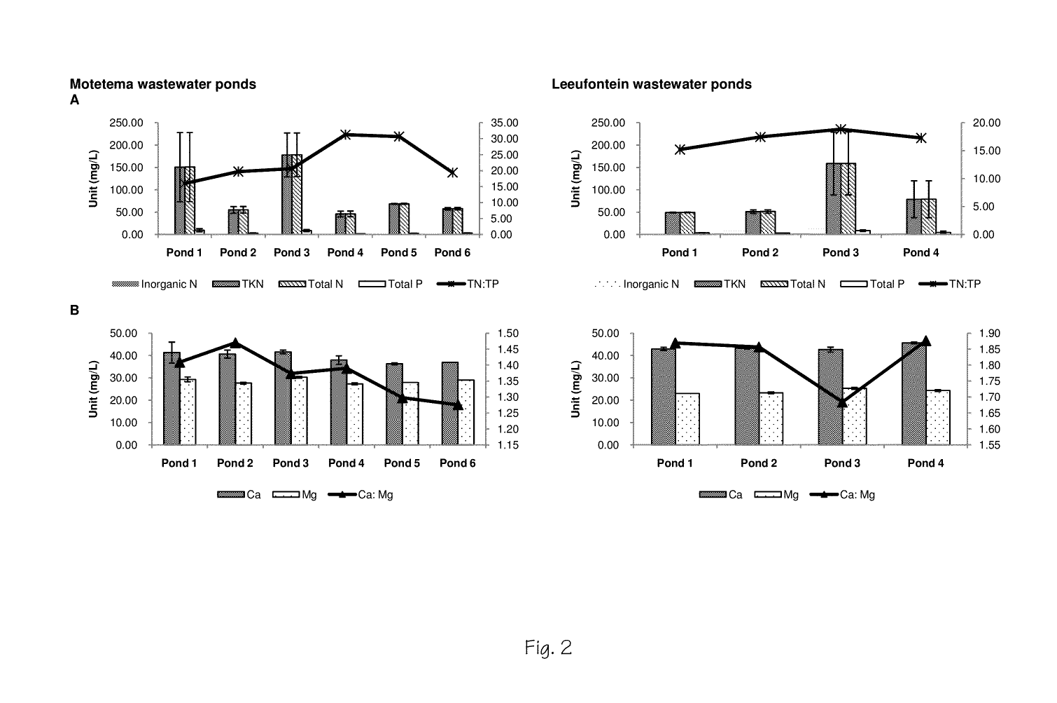

FIG. 2 shows, for the Example, the physicochemical properties of the Motetema and Leeufontein ponds with nitrogen and phosphorous profiles and their relation to each pond, and the composition of Ca and Mg ratios, being shown;

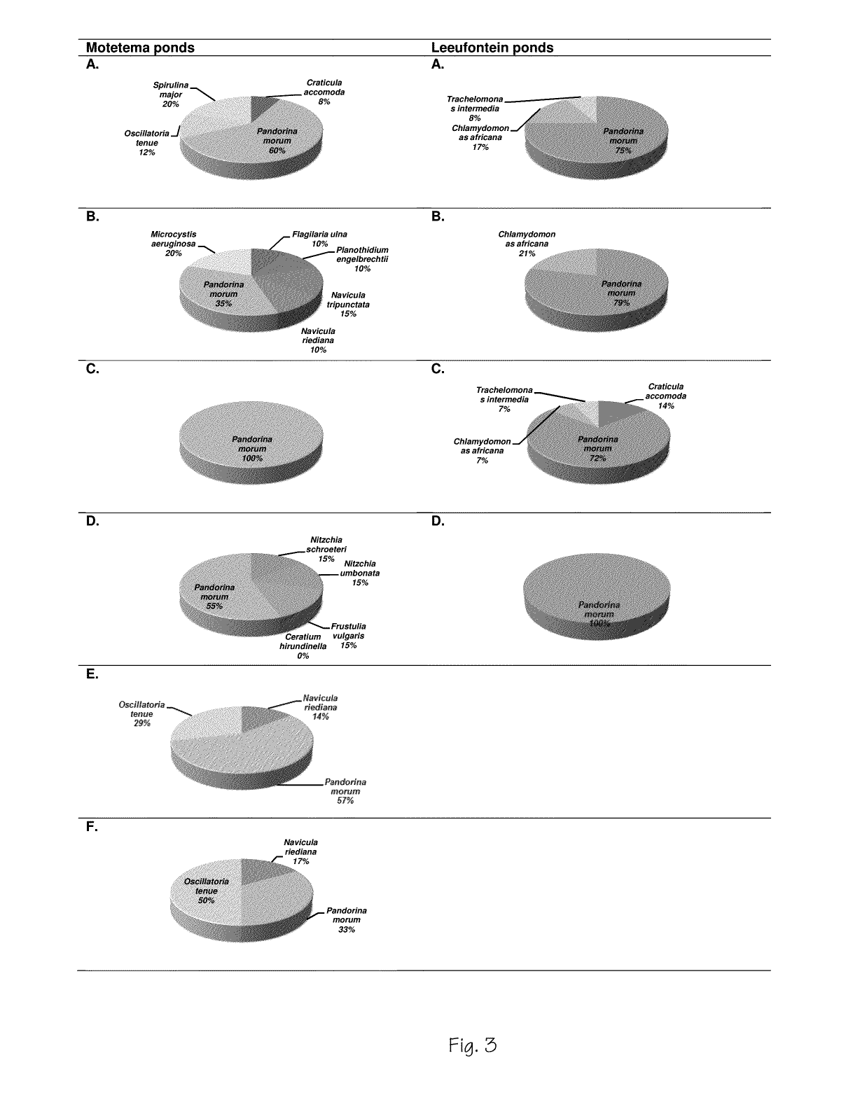

FIG. 3 shows, for the Example, indigenous algal specie distribution in each of the Motetema and Leeufontein ponds;

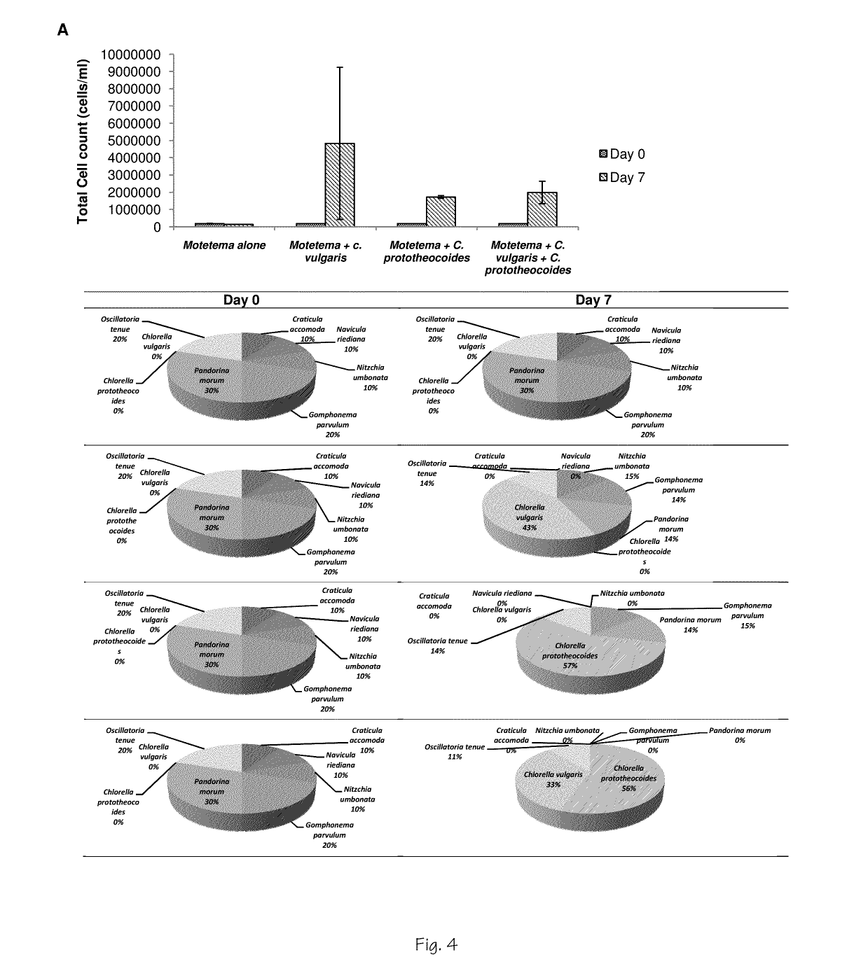

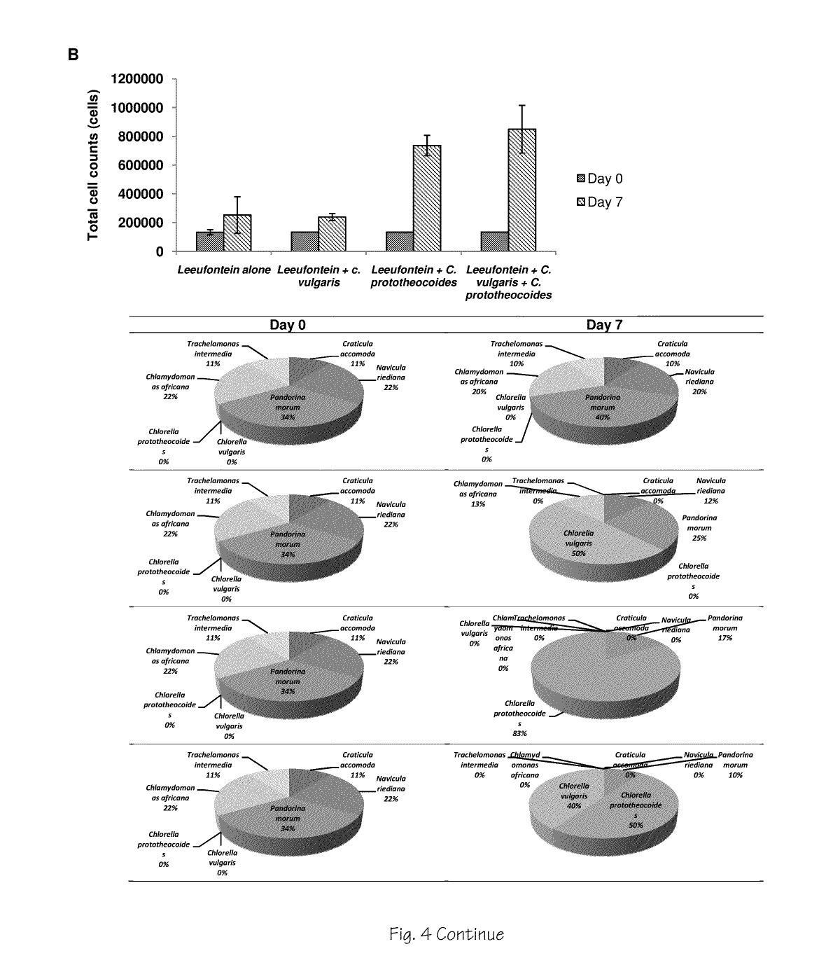

FIG. 4 shows, for the Example, competition experiments against indigenous microbial consortia, with (A) Motetema and (B) Leeufontein exposures to different algae and combination of algae against microbials from either Motetema or Leeufontein;

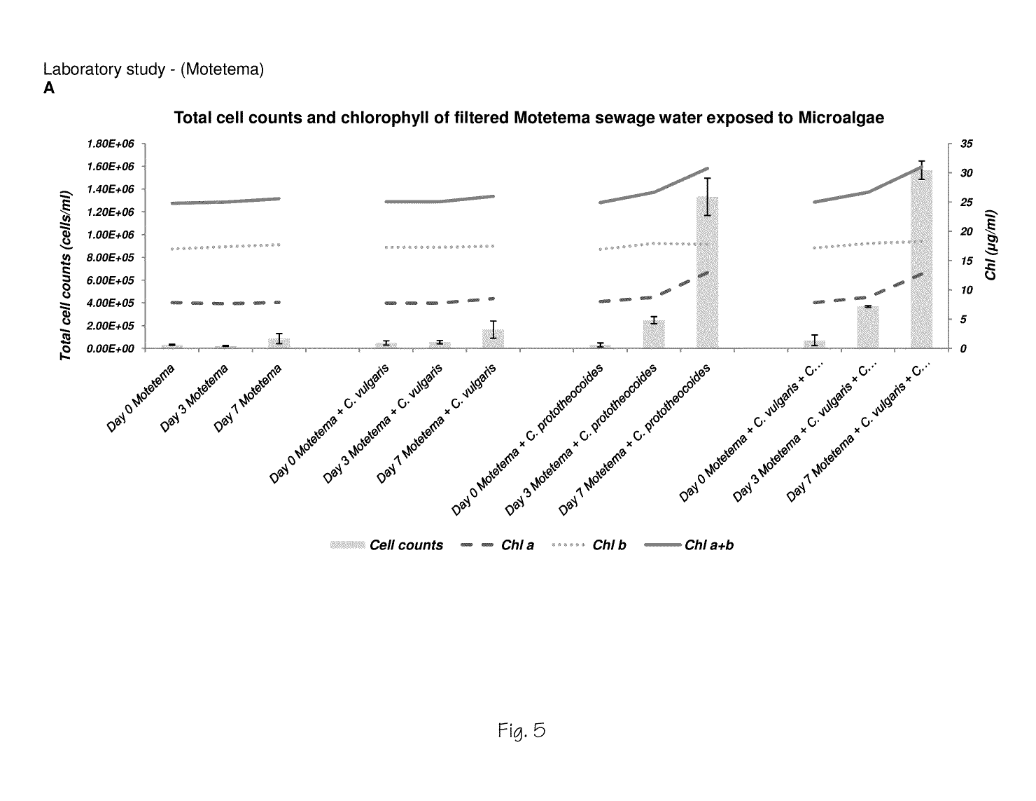

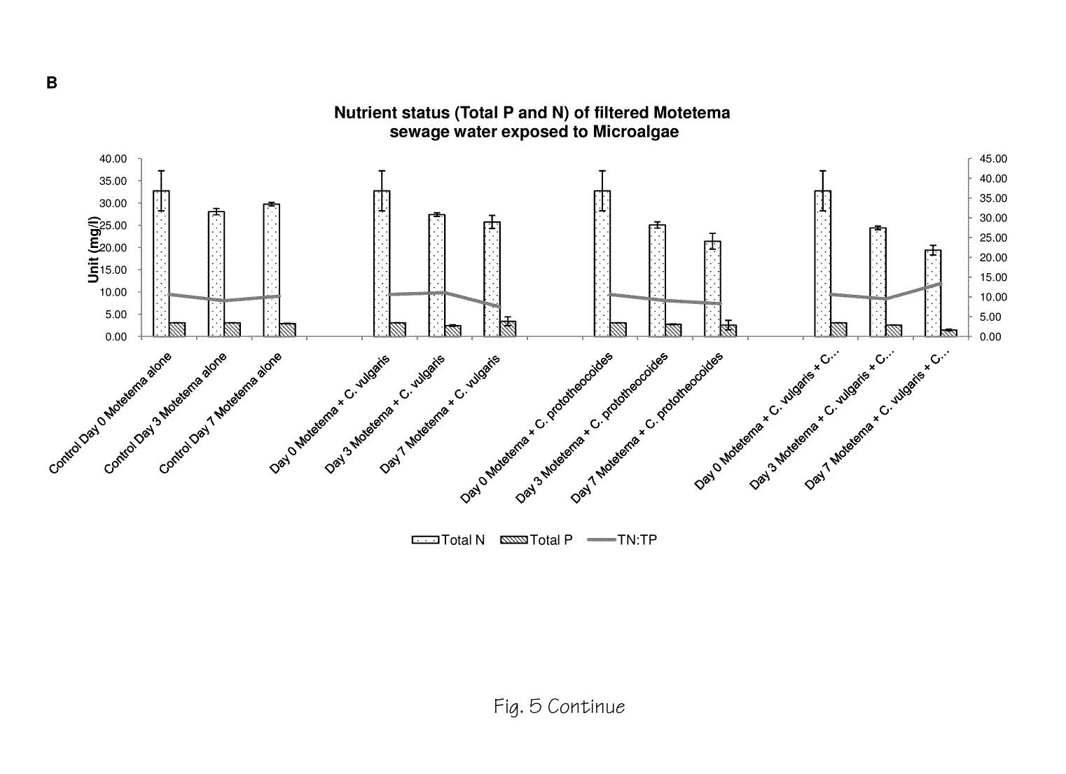

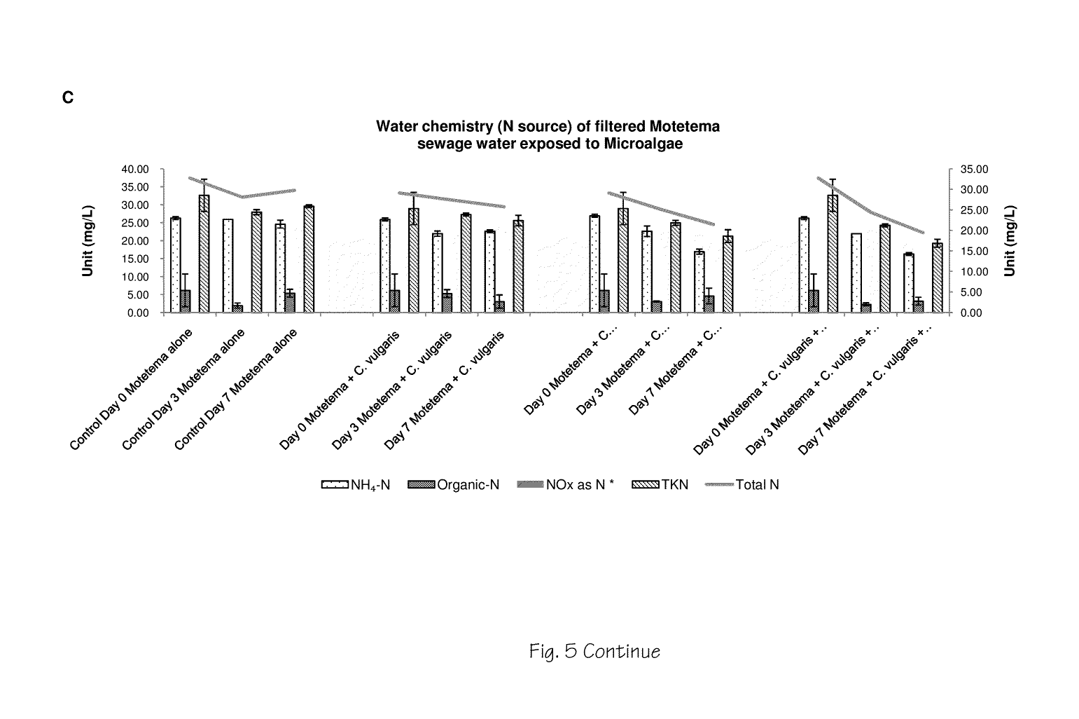

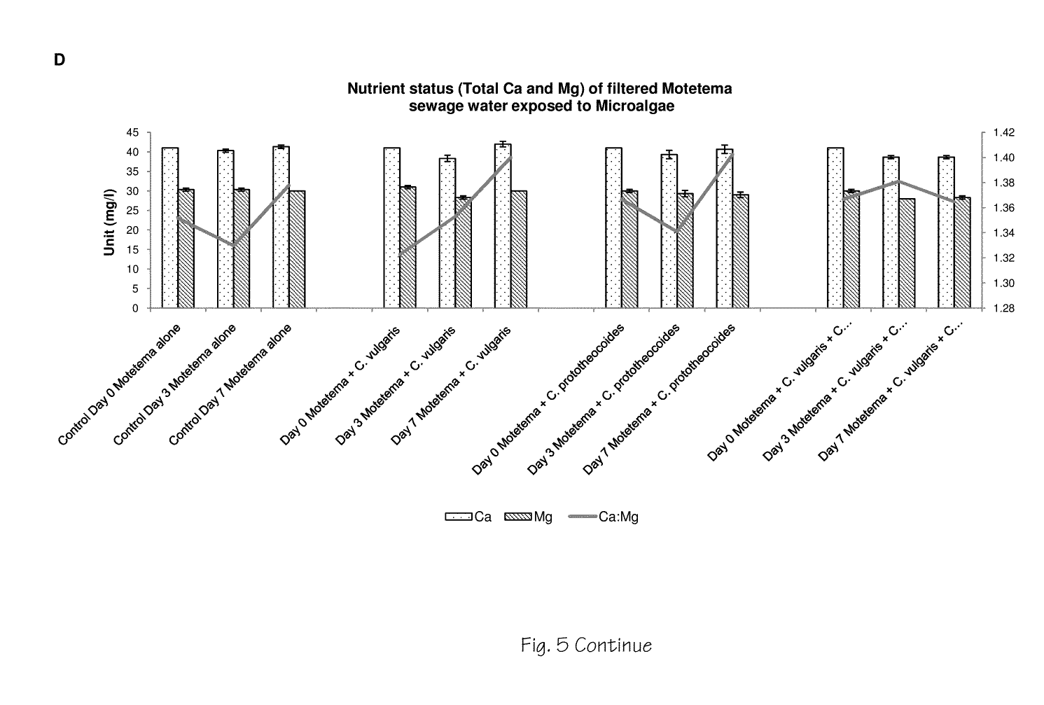

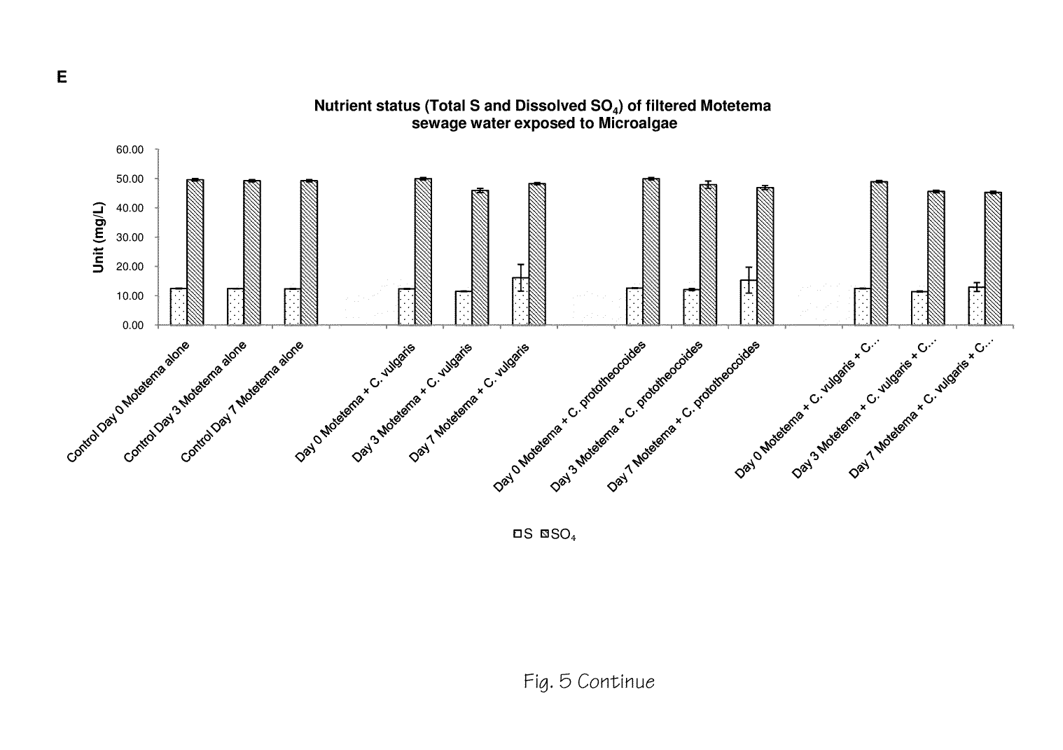

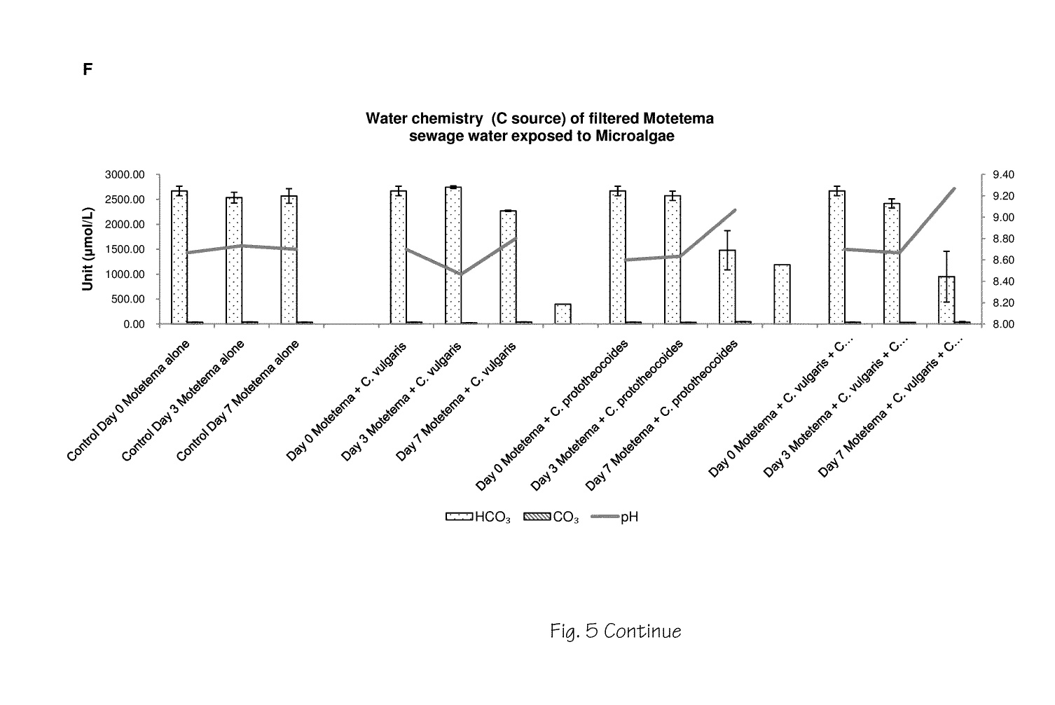

FIG. 5 shows, for the Example, mean concentrations of pollutants in 0.45 μm filtered Motetema waste water; and;

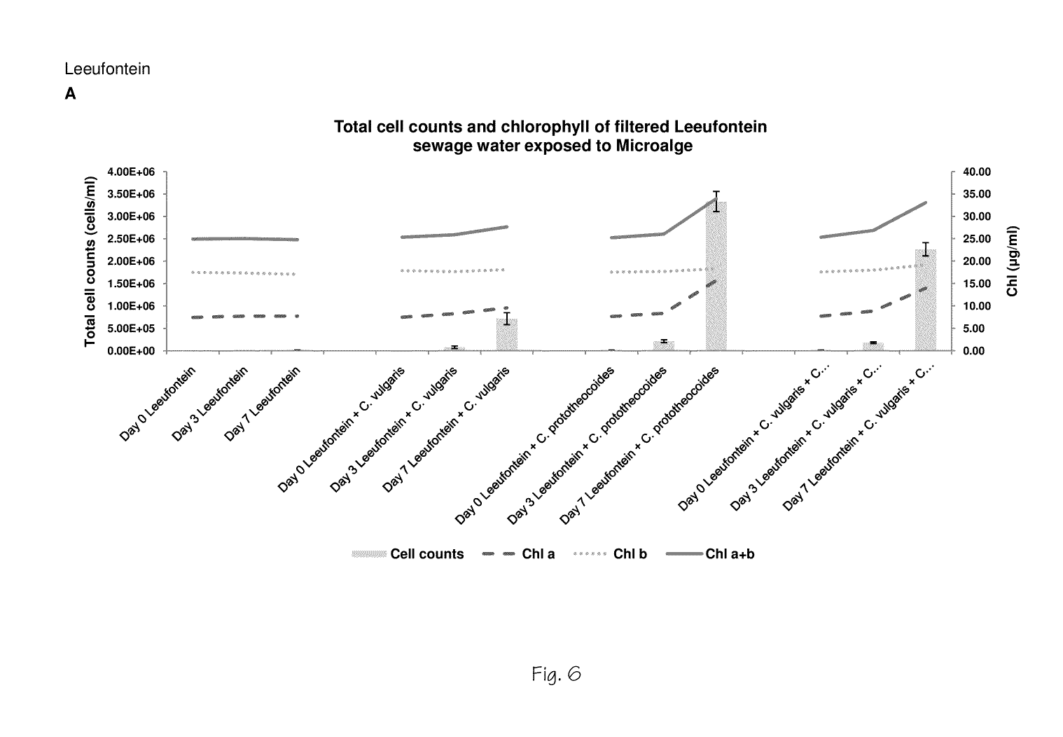

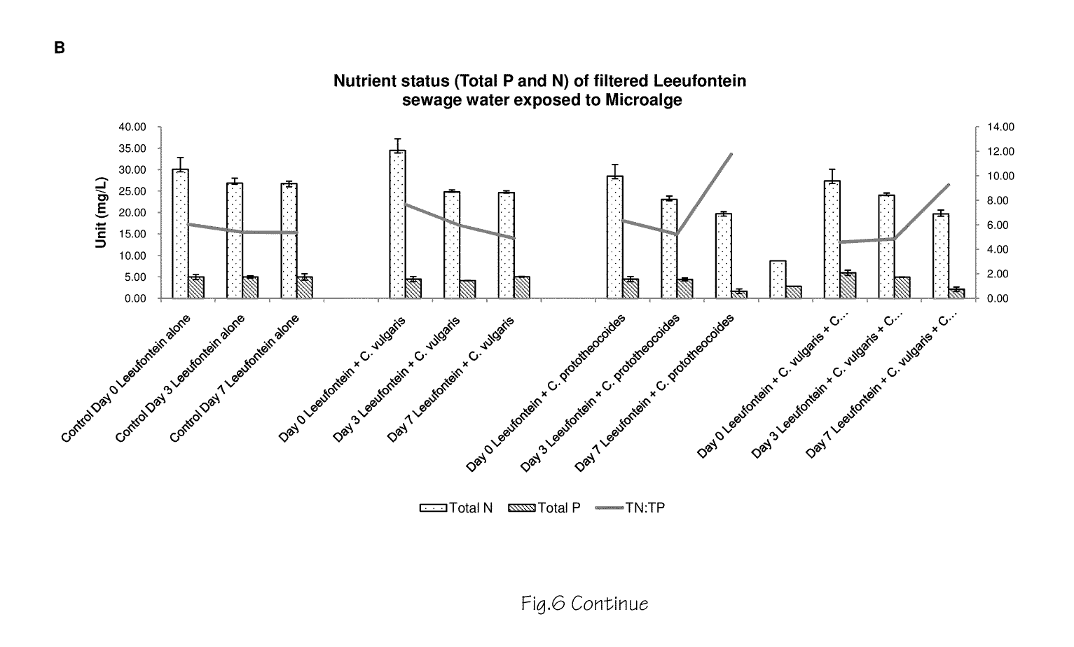

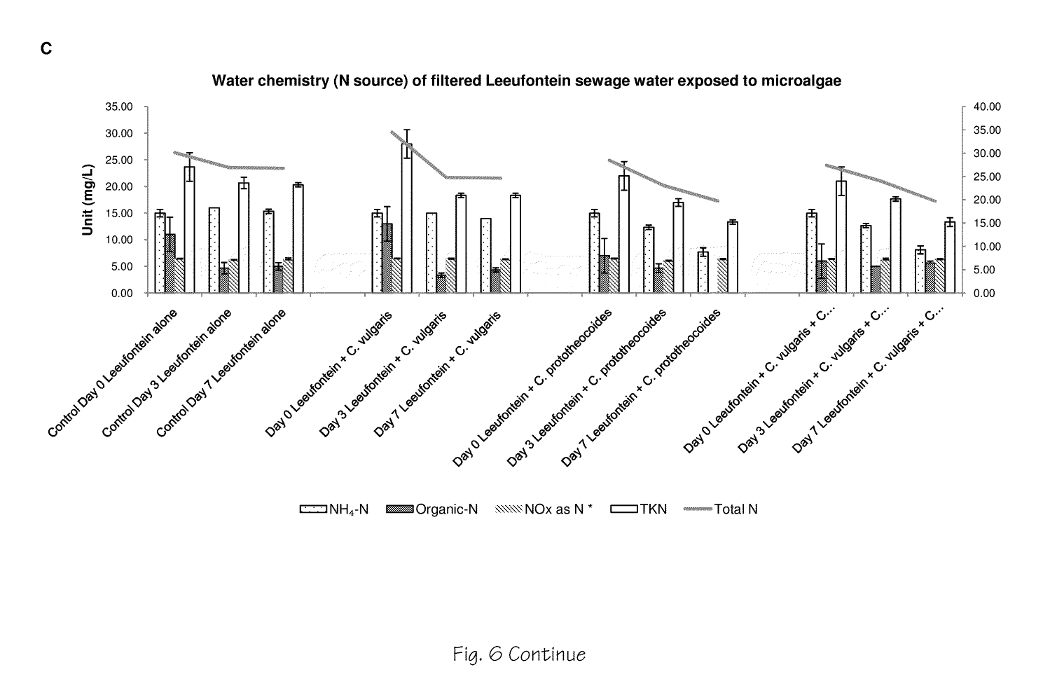

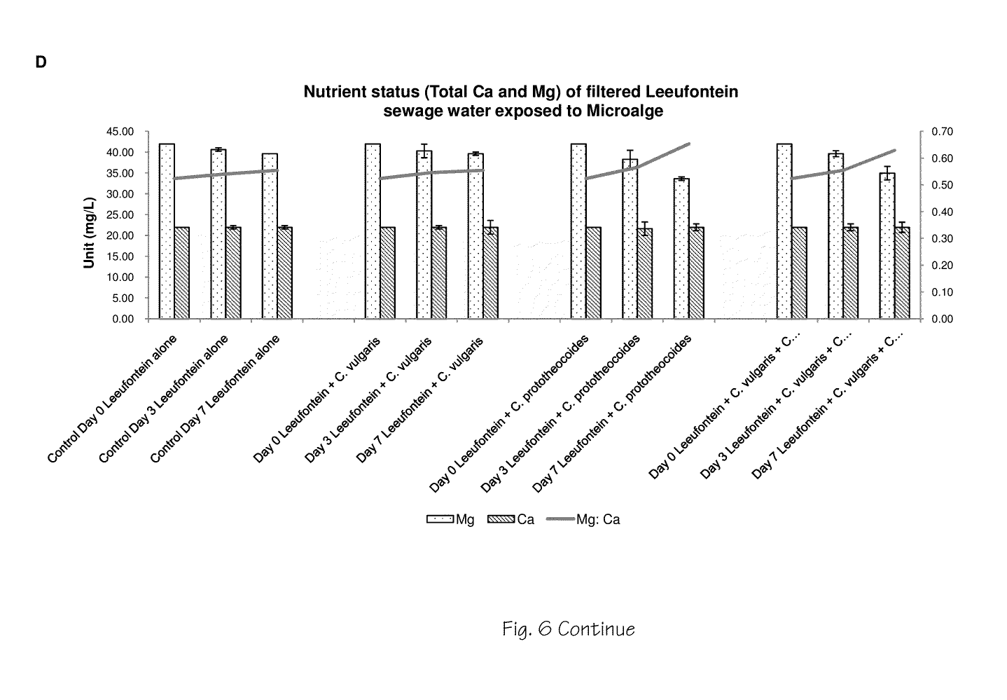

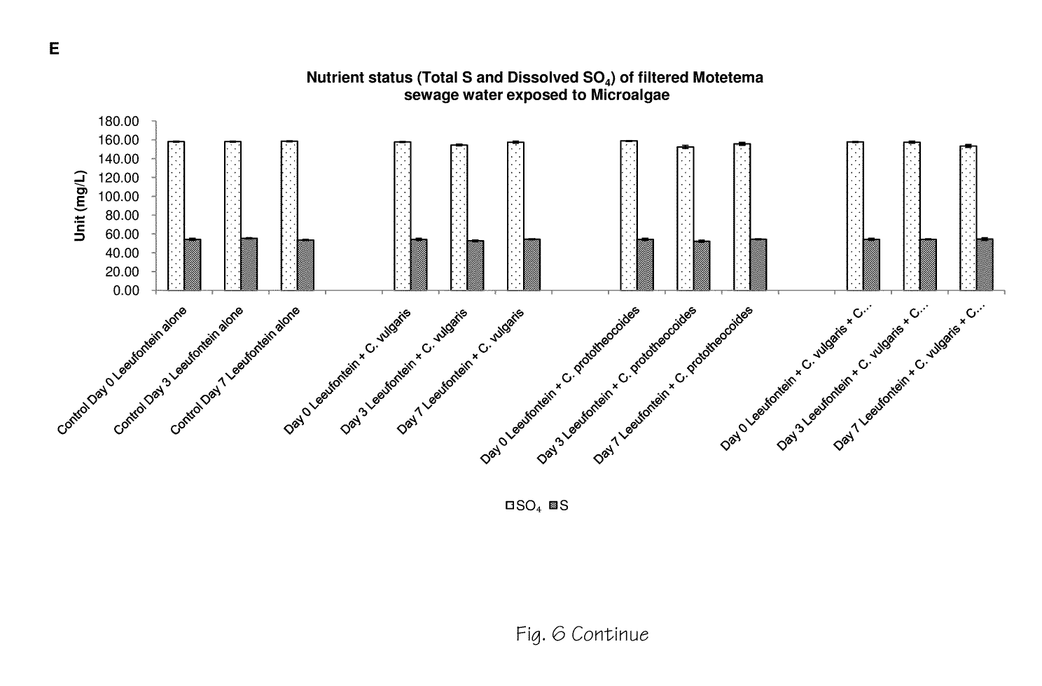

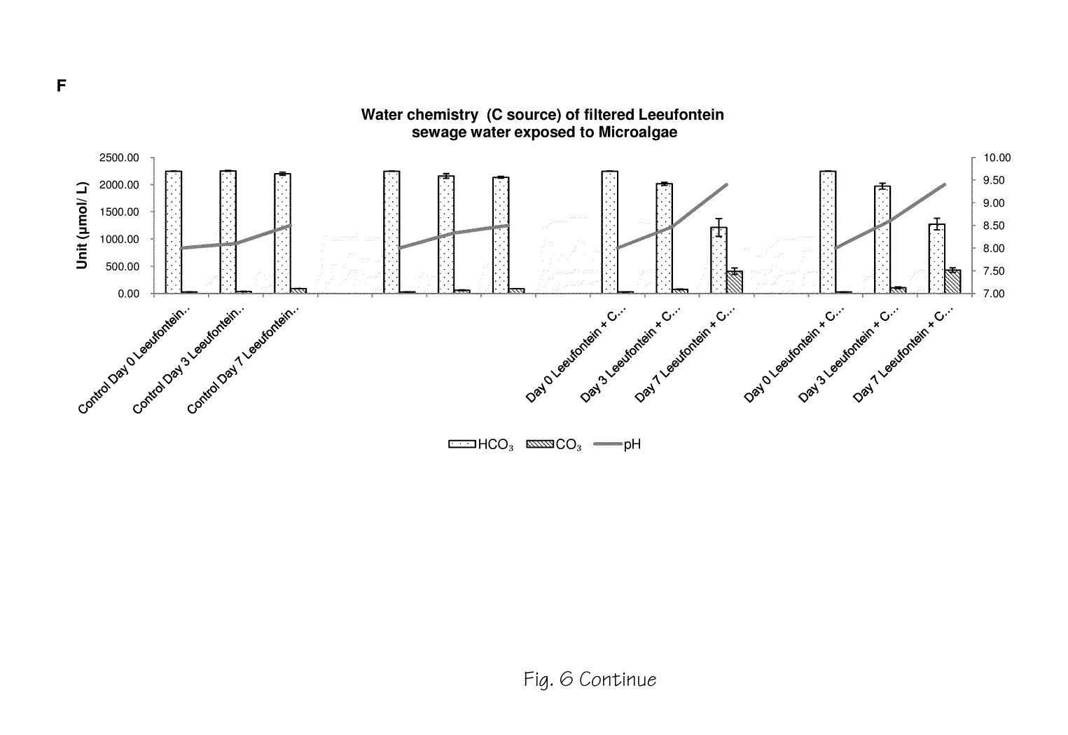

FIG. 6 shows, for the Example, mean concentrations of pollutants in 0.45 μm filtered Leeufontein waste water.

Referring to FIG. 1, reference numeral 10 generally indicates a continuous process for treating domestic sewage, in accordance with the invention.

The process 10 includes a primary treatment stage 12 comprising a deep pond 14, having a depth of 2-5 metres. A sewage flow line 16 leads into the pond 14. Metal removal is effected in the pond 14, in conventional fashion.

A transfer line 18 leads from the primary treatment stage 12 to a secondary treatment stage 20 comprising a secondary pond 22 in which digestion of organic material, to reduce ammonia loading, takes place, also in conventional fashion. An algal component 24, comprising C. prototheocoides or an algal combination of C. prototheocoides and C. vulgaris, can be introduced into the pond 22, if desired.

A transfer line 28 leads from the second treatment stage 20 to a tertiary treatment stage 30 comprising a shallow (0.5-1 m deep) pond 32. The algal component 24, which thus comprises cultured cells of the desired species, i.e. C. prototheocoides or the algal combination of C. prototheocoides and C. vulgaris produced in an xenic culture stage (not shown), is introduced into the pond 32, for nutrient, especially N and P, removal from the sewage, by means of passive phycoremediation in accordance with the invention. There is thus no mechanical agitation or aeration of the pond 32.

A transfer line 34 leads from the tertiary treatment stage 30 to an algal removal stage 40 comprising a pond 42 into which zooplankton Daphnia sp is introduced along line 44. Algal proliferation is controlled by means of the zooplankton. Treated water/effluent is withdrawn from the stage 40 along a line 46.

The process 10 is continuous, i.e. the various ponds are sized so that the waste water has a sufficient retention time in each pond to achieve a desired result, in particular to reduce its P content to meet the requirements of the Green Drop Progress Report by DWA. In particular, the ponds 32 and 42 are shallow with large surface areas so that the algae will have a sufficient residence time therein.

### EXAMPLE

### Objective

An objective was to treat effluent using phycoremediation technology as primary treatment.

More particularly, specific algae species, namely Chlorella vulgaris or Chlorella prototheocoides alone or a combination of these two algae (hereinafter also referred to as “the algal combination”), together with a polishing step using zooplankton Daphnia sp., were investigated, under laboratory conditions, in treating the effluent of both Motetema and Leeufontein rural waste water treatment works (WWTWs), in South Africa.

Rural area treatment ponds have been traditionally used in South Africa for decentralized treatment of domestic sewage. These treatment ponds are cost effective as they depend mainly on natural processes without any external energy inputs. Thus, recycling nutrients back from this effluent before discharging to the public drains by waste reclamation via algal culture is of interest to improve water resource assimilation capacity. This study aimed to investigate nutrient assimilation and proliferation trends of Chlorella vulgaris, C. prototheocoides. This was through algal treatment as a final step in treating effluents of Motetema and Leeufontein waste water works (WWTWs) which consist of a train of saturate ponds. The algae were used separately and in combination as a treatment of these ponds.

### Methodology Overview

1. Isolation and identification of microalgae specie in the waste water systems;
2. Cultivation of the microalgae;
3. Competition experiments using C. vulgaris, C. prototheocoides and the algal combination against a microbial consortium from each waste water pond site;
4. Daphnia feeding, and its efficiency removal of algae and microbes;
5. Identification of the efficiency of nutrient removal (specifically P and N) using C. vulgaris, C. prototheocoides or the algal combination that is specific to the different waste waters; and
6. Estimation of the amounts of C. vulgaris, C. prototheocoides and the algal combination required, and time requirement needs, to remove nutrients from the waste water treatment plants.

### Materials and Methods

### Sample Collection, Identification and Cultivation of Algae

C. vulgaris and C. prototheocoides were isolated from wetlands in the upper Olifants river catchment, Mupumalanga, South Africa and were grown in Algal culture broth (Sigma-aldrich, Germany). To establish axenic cultures, culturing of algal material was performed using standard aseptic techniques. The work was carried out in a horizontal laminar flow cabinet. Inoculants were tested regularly for contamination using microscopic inspections. Subculturing C. vulgaris and C. prototheocoides for isolation and purification work, as well as routine subculturing of stock cultures, was performed by transferring algal material with a sterile needle or wire loop and washed three times with sterile PBS (Phosphate Battered Saline) (pH 7.5; Lonza, Switzerland) buffer containing 10 mg/L germanium dioxide. After the different algae were isolated and washed, they were grown in 300 ml of algae culture broth (Sigma-Aldrich Chemie GmbH, Switzerland) medium supplemented with 10 mg/L germanium dioxide to inhibit diatom growth. Uniform inoculants for experimental work were subcultured from liquid media using a Gilson Adjustable Volume Pipetman with sterilised plastic tips, to dispense a known volume of suspension.

The algal culture was cultured in the absence of aeration at 20° C. with a light intensity of 100 μmol/m²/s (with circadian rhythm of 12 hours day: 12 hours night). To verify whether or not the microalgae cultures were axenic, a compound microscope at 1250× magnification was used to examine the different cultures every 3 days; if the cultures were not axenic the isolation procedure was repeated. Long-term laboratory axenic cultures of Chlorella's were maintained by routine serial subculture over 3 months. Each Chlorella's culture was cultivated for 14 days in liquid algal culture broth (Sigma-aldrich, Germany).

### Description of Site and Characteristics of Waste Water

Motetema and Leeufontein WWTWs were chosen and waste waters from ponds at these WWTWs were used. Motetema WWTW (total of 12 ponds, of which only 6 ponds were functional) is situated at Elias Motsoaledi, Sekhukhune District of Limpopo province, South Africa. The average total effluent generated per day by a population of ˜11400, for the Motetema WWTW, amounted to ˜2.5 ML/day. The average total effluent generated per day by a population of ˜16903, for the Leeufontein WWTW amounted to ˜0.5 ML/day.

The physicochemical properties of the Motetema ponds are given in Table 1.

TABLE 1
Physiochemical properties of Motetema ponds

| | | Motetema | Motetema | Motetema | Motetema | Motetema | Motetema |
|---|---|---|---|---|---|---|---|
| Sample ID | | Pond 1 | Pond 2 | Pond 3 | Pond 4 | Pond 5 | Pond 6 |
| Potassium as K Dissolved | mg/l | 17.67 | 10.83 | 24.33 | 11.67 | 18.00 | 17.33 |
| Sodium as Na Dissolved | mg/l | 82.67 | 81.33 | 85.67 | 84.00 | 83.67 | 85.33 |
| Ammonia as N | mg/l | 46.67 | 22.00 | 38.33 | 14.00 | 21.33 | 19.67 |
| Chloride as Cl | mg/l | 54.33 | 54.67 | 58.67 | 54.33 | 55.00 | 56.00 |
| Alkalinity as CaCO₃ | mg/l | 493.33 | 324.67 | 448.00 | 262.00 | 387.00 | 421.67 |
| Nitrate + Nitrite as N | mg/l | 0.10 | 0.10 | 0.10 | 0.10 | 0.10 | 0.10 |
| Nitrate | mg/l | 0.10 | 0.10 | 0.10 | 0.10 | 0.10 | 0.10 |
| Nitrite as N | mg/L | 0.10 | 0.10 | 0.10 | 0.10 | 0.10 | 0.10 |
| ortho Phosphate as P | mg/l | 6.73 | 2.00 | 6.80 | 0.72 | 2.17 | 2.53 |
| Electrical Conductivity | mS/m (25° C.) | 120.33 | 92.00 | 111.33 | 88.67 | 92.67 | 93.33 |
| pH (Lab) (20° C.) | | 7.77 | 8.07 | 7.63 | 7.97 | 8.03 | 7.83 |
| Saturation pH (pHs) (20° C.) | | 7.33 | 7.50 | 7.37 | 7.60 | 7.47 | 7.43 |
| Hardness as CaCO₃ | mg/l | 224.00 | 215.67 | 229.00 | 207.67 | 206.00 | 212.00 |
| Chemical Oxygen Demand | mg/l | 3488.67 | 991.00 | 1742.67 | 652.33 | 499.33 | 466.33 |
| Ryznar Index | | 6.90 | 6.93 | 7.10 | 7.23 | 6.90 | 7.03 |
| Total Dissolved Solids | mg/L | 506.67 | 498.67 | 504.00 | 500.00 | 535.33 | 492.00 |
| (Measured) | | | | | | | |
| Suspended Solids | mg/l | 1615.67 | 665.33 | 972.33 | 556.33 | 287.33 | 318.67 |
| Ca Hardness as CaCO₃ | mg/L | 103.00 | 101.33 | 103.67 | 94.67 | 90.67 | 92.00 |
| Mg Hardness as CaCO₃ | mg/L | 120.67 | 113.67 | 125.33 | 112.33 | 115.00 | 119.00 |
| Redox potential | | 61.00 | 50.33 | 61.67 | 41.67 | 35.67 | 35.00 |
| Biological Oxygen Demand # | mg/l | 1295.00 | 673.67 | 482.89 | 309.11 | 268.33 | 300.67 |

Leeufontein WWTW (total of 5 ponds only 4 of which were functional) is situated in Ephraim Mogale, Sekhukhune District of Limpopo province, and is connected upstream of the Olifants river. The Olifants river is one of the most polluted rivers in South Africa.

The physicochemical properties of the Leeufontein ponds are given in Table 2.

TABLE 2
Physiochemical properties of Leeufontein ponds

| | | Leeufontein | Leeufontein | Leeufontein | Leeufontein |
|---|---|---|---|---|---|
| Sample ID | | Pond 1 | Pond 2 | Pond 3 | Pond 4 |
| Potassium as K Dissolved | mg/l | 18.33 | 20.00 | 25.33 | 23.33 |
| Sodium as Na Dissolved | mg/l | 127.67 | 127.00 | 134.00 | 135.00 |
| Ammonia as N | mg/l | 23.00 | 22.67 | 48.33 | 24.67 |
| Chloride as Cl | mg/l | 95.33 | 96.67 | 115.00 | 102.67 |
| Alkalinity as CaCO₃ | mg/l | 299.67 | 313.33 | 513.67 | 350.00 |
| Nitrate + Nitrite as N | mg/l | 0.10 | 0.10 | 0.10 | 0.10 |
| Nitrate | mg/l | 0.10 | 0.10 | 0.10 | 0.10 |
| Nitrite as N | mg/L | 0.10 | 0.10 | 0.10 | 0.10 |
| ortho Phosphate as P | mg/l | 0.40 | 1.01 | 9.50 | 2.05 |
| Electrical Conductivity | mS/m (25° C.) | 115.33 | 116.67 | 142.00 | 121.33 |
| pH (Lab) (20° C.) | | 7.97 | 7.87 | 7.47 | 7.83 |
| Saturation pH (pHs) (20° C.) | | 7.50 | 7.50 | 7.30 | 7.40 |
| Hardness as CaCO₃ | mg/l | 202.33 | 204.33 | 210.67 | 214.33 |
| Chemical Oxygen Demand | mg/l | 379.00 | 376.00 | 1181.00 | 290.33 |
| Ryznar Index | | 7.03 | 7.13 | 7.13 | 6.97 |
| Total Dissolved Solids | mg/L | 665.33 | 694.67 | 706.67 | 716.00 |
| (Measured) | | | | | |
| Suspended Solids | mg/l | 140.67 | 174.00 | 565.00 | 177.33 |
| Ca Hardness as CaCO₃ | mg/L | 107.33 | 108.00 | 106.33 | 114.00 |
| Mg Hardness as CaCO₃ | mg/L | 95.00 | 96.33 | 104.33 | 100.33 |
| Redox potential | | 18.33 | 25.67 | 43.00 | 21.00 |
| Biological Oxygen Demand # | mg/l | 279.00 | 116.24 | 237.80 | 226.00 |

Three samples of each pond per site were collected for experimental purposes.

Exposure of Waste Water to C. vulgaris and C. prototheocoides

Total existing cell collection counts exposed to waste water of each pond site (Motetema pond 6, Leeufontein pond 4) were measured using a Countess automated cell counter (Invitrogen, Calif., USA). An algal component comprising C. vulgaris, C. prototheocoides or the algal combination was exposed to waste water effluent in the ratio of 1:1000 based on the total cell counts. Waste water effluent without the algal component served as a control. These algae were thus used to compete with the indigenous bacteria and algae species. Total cell counts were recorded before exposure and after 7 days. The growth rate of total algal biomass was expressed relative to total chlorophyll and was measured before exposure and after 7 days according to standard procedures of Porra et al. (1989). Dominance of algae species was examined using a compound microscope at 1250× magnification.

Physicochemical Analysis of Waste Water from Waste Water Treatment Plants

Samples collected from the field were filtered through 0.45 μm cellulose nitrate filters prior to the following analyses. Each analysis was expressed relative to the standard: Ammonia and ortho-phosphate, Nitrate and Nitrite, Chloride and Fluoride, Potassium, Sodium, Magnesium, Sulphate, Calcium, and Hardness as CaCO₃. Unfiltered samples collected from field were used in the following analyses: Electrical Conductivity, Chemical Oxygen Demand (COD), Total Nitrogen (TN) and Total phosphate (TP), pH (Pitwell, 1983; EPA, 1983; Clescerl et al. 1998).

Toxicological Analysis Using Daphnia magna

For screening purposes, acute 48 hour Daphnia assays (EPA, 2002) were conducted. Daphnia magna (n=5) were exposed to 50 ml volumes of waste water effluent. These waste water effluents contain total cell counts 1:100 fold less C. vulgaris, C. prototheocoides or the algal combination. The number of surviving algae and Daphnia was recorded every 24 hours until the end of the exposure period.

Physicochemical Analysis of Filtered Waste Water after Exposure to Chlorella sp. Under Laboratory Condition

To observe the efficiency of the selected algal strains without the interference of microbes and sediments, effluent obtained from pond 6 (final pond before outflow to river stream) from Motetema and pond 4 (final pond before outflow to river stream) from Leeufontein was centrifuged at 6000×g for 5 min at 20° C., followed by subsequent filtration using 0.45 μm low binding filtering cup (Millipore, Merck Darmstadt, Germany).

Experiments were conducted in triplicate, using aliquots of 500 ml filtrate. Filtrates were exposed to either C. vulgaris alone, C. prototheocoides alone or to the algal combination, with a total concentration of 10 000 cells/ml. Filtered water samples without any of the algae components were used as controls. Samples of 1 ml were collected at day 0, day 3 and day 7 for chlorophyll a and b determination, which was done according to Porra et al. (1989). 10 ml of each sample were collected and total cell counts were recorded using Countess automated cell counter (Invitrogen, USA) at day 0, day 3 and day 7.

Both unexposed and exposed samples (at time day 0, day 3, day 7) were re-filtered with 0.45 μm low binding filtering cup (Millipore, Merck Darmstadt, Germany) prior to physicochemical analysis as hereinbefore described.

### Statistical Analysis and Principle Component Analysis

All variables were previously log-transformed to reduce skewed distributions. Two way ANOVA (site and time) was used to determine physicochemical and biological differences: (i) among algae tested, (ii) different nutrients having different temporal variations. To perform this analysis, parameters with three replicates per exposure time were used. Homogeneity of variances and normality of data were checked prior to data analysis (Davis, 1973). If significant differences were found (p<0.05), the ANOVA was followed by a Tukey-b test. Pearson correlations were performed in order to explore the relation between algae treatment and between time window. All these analyses were done with SPSS v15.0 software.

### Results and Discussion

The provision of sanitation in Sekhukhune is a huge challenge and even more of a concern than water. The sanitation backlog is primarily within the rural villages, comprising 78% of households without adequate sanitation. A slight majority of the schools in the district (53%) is provided with RDP standard sanitation services, while 63% of clinics receive below RDP standard sanitation services. The Green Drop report (DWA, 2012) noted that all 17 of the WWTWs in this region were in high (11) and critical (6) risk positions making Sekhukhune the highest risk municipality in the Province. This presents a potential high risk situation to public health and ecosystem service downstream of these WWTW.

The general properties of effluent discharge according to Green Drop are water with a phosphate content limit of 10 mg/l. The phosphate content in these ponds was lower; however this was not suitable for drinking purposes. From Table 1 and Table 2, it is clear that orthro-phosphates and COD fluctuated from Pond 1 to Pond 6 of Motetema and from Pond 1 to Pond 4 of Leeufontein. However, nitrates were found to be below detection limit in both Motetema and Leeufontein WWTW; this indicates that both nitrate and nitrite from these sites are not major nitrogen (N) contributors, but rather that ammonia is. Ammonia in these ponds which was above 10 mg/l EPA limit as indicated in Table 3. In case of biological oxygen demand (BOD), a large-scale increase in the nutrient input in pond 1 suggests the water bodies induce faster algae growth which causes imbalanced trophic structure, and reduced dissolved oxygen concentrations from pond 1 to the last pond of both sites.

Table 3 gives the physicochemical characteristics of waste water from the final ponds of the Motetema and Leeufontein WWTWs.

TABLE 3
Characteristics of Motetema and Leeufontein waste water from
final ponds prior to being discharged to the river stream.

| | | Motetema | Leeufontein | DWAF standard | DWAF standard |
|---|---|---|---|---|---|
| Sample ID | | Pond 6 | Pond 4 | (General limit) | (Special limit) |
| Potassium as K Dissolved | mg/l | 17.33 | 23.33 | | |
| Sodium as Na Dissolved | mg/l | 85.33 | 135.00 | | |
| Ammonia as N | mg/l | 19.67 | 24.67 | <10 (EPA) | |
| Chloride as Cl | mg/l | 56.00 | 102.67 | | |
| Alkalinity as CaCO₃ | mg/l | 421.67 | 350.00 | | |
| Nitrate + Nitrite as N | mg/l | 0.10 | 0.10 | | |
| Nitrate | mg/l | 0.10 | 0.10 | <50 | |
| Nitrite as N | mg/L | 0.10 | 0.10 | | |
| ortho Phosphate as P | mg/l | 2.53 | 2.05 | <4 (EPA) | <2.5 |
| Electrical Conductivity | mS/m (25° C.) | 93.33 | 121.33 | <75 | <30 |
| pH (Lab) (20° C.) | | 7.83 | 7.83 | 5.5~9.5 | 5.5~7.5 |
| Saturation pH (pHs) (20° C.) | | 7.43 | 7.40 | | |
| Hardness as CaCO₃ | mg/l | 212.00 | 214.33 | | |
| Chemical Oxygen Demand | mg/l | 466.33 | 290.33 | <100 (EPA) | |
| Ryznar Index | | 7.03 | 6.97 | | |
| Total Dissolved Solids | mg/L | 492.00 | 716.00 | | |
| (Measured) | | | | | |
| Suspended Solids | mg/l | 318.67 | 177.33 | <25 | <10 |
| | | | | <30 (EPA) | |
| Ca Hardness as CaCO₃ | mg/L | 92.00 | 114.00 | | |
| Mg Hardness as CaCO₃ | mg/L | 119.00 | 100.33 | | |
| Redox potential | | 35.00 | 21.00 | | |
| Biological Oxygen Demand # | mg/l | 300.67 | 226.00 | <30 (EPA) | |

These field analyses suggest that current passive treatment is not efficient in reduction of total phosphorous and total nitrogen. Hence a need for a final effective polishing step.

Nitrogen and phosphorus, enter lakes or river system from various sources. Nutrient input into a more stable ecosystem causes eutrophication. It induces changes in the ecosystem functioning and increases primary production in upper Olifants river system. Township sewage in Motetema and Leeufontein are the major sources of nitrogen and phosphorous. A considerable bulk of human waste is ammonia which thus enters these passive sewage treatment ponds.

In these waste water treatment ponds, the water column of a ratio between total nitrogen and total phosphorus (TN/TP) ranged from eutrophic state of pond 1 in Motetema and ended with an eutrophic state of pond 6 in Motetema. Trophic state in Leeufontein WWTW ranged from an eutrophic state of pond 1 and ended with an eutrophic state in pond 4 (FIG. 2A). This further suggested that discharge of current passive treatment of the effluent holds great environmental risk of eutrophying the river system. Therefore, implementing zooplankton is important to remove excess algae prior to discharge.

Magnesium and calcium, further important limiting factors, play important roles in eutrophication. The depletion of magnesium (due to its binding into the chlorophyll molecule) acts as a limiting factor for the growth of phytoplankton. It is known that an increase in population of phytoplankton is related to the amount of magnesium available. The concentration of magnesium in the Motetema ponds displays a consistently reduced trend; however this was not the case in Leeufontein (FIG. 2B). The calcium in these ponds was found to have no significant difference or reduction on progression of each pond from both treatment plants (FIG. 2B). A ratio of Ca:Mg greater than 4 suggests a risk of development of green filamentous algae (FIG. 2B). In all these ponds, absence of green filamentous algae was expected.

Eutrophication is one of several mechanisms by which cyanobacteria, mainly blue green algae (harmful algae), appear to be increasing in magnitude and duration in many locations under warmer conditions. Although important, it is not the only explanation for blooms or toxic outbreaks of filamentous cyanobacteria. Some studies have suggested a strong link between stimulation of some harmful species and nutrient enrichment, but in others it has not been an apparent contributing factor. The overall effect of nutrient over-enrichment on harmful algal species is clearly species specific.

The addition of nutrients to these ponds was largely bound to the inedible component of the phytoplankton such as cyanophyta, which is avoided by planktivorous fish and zooplanktons because of their toxicity and taste. Indigenous species found in Motetema consist of the following: Pond 1 consist mainly four major classes, chlorophyta (dominant specie of 60%: Pandorina morum), bacillariophyta (Craticula accomoda), Euglenophyta (Oscillatoria tenuis) and cyanophyta (Spirulina major; FIG. 3). Pond 2 consists of mainly 3 major classes, bacillariophyta (Flagilaria ulna, Planothidium engelbrechtii, Navicula tripunctata, Navicula riediana), chlorophyta (dominant specie of 35%: Pandorina morum) and cyanophyta (Microcystis aeruginosa; FIG. 3). Pond 3, dominated by chlorophyta (dominant specie of 100%: Pandorina morum; FIG. 3C). Pond 4 consists of 2 major classes bacillariophyta (Nitzchia schroeteri, Nitzchia umbonata and Frustulia vulgaris) and chlorophyta (dominant specie of 55%: Pandorina morum; FIG. 3D). Pond 5 consists of cyanophyta (Oscillatoria tenuis), Bacillariophyta (Navicula riediana) and chlorophyta (dominant specie of 57%: Pandorina morum; FIG. 3E). Pond 6 consists of 3 major classes cyanophyta (Dominant specie of 50%: Oscillatoria tenuis), bacillariophyta (Navicula riediana) and chlorophyta (Pandorina morum; FIG. 3F).

Indigenous specie identified in Leeufontein consist of the following: Pond 1 consist mainly two classes of algae chlorophyta (Chlamydomonas africana and dominant specie: 75% of Pandorina morum) and euglenophyta (Trachelomonas intermedia; FIG. 3A). Only Chlorophyta class were identified in Pond 2 (Chlamydomonas africana, where Pandorina morum found to be dominant 79% of total algal population; FIG. 3B). In pond 3 three classes were identified mainly bacillariophyta (Craticula accomoda), Chlorophyta (dominant specie 72%: Pandorina morum and Chlamydomonas africana) and euglenophyta (Trachelomonas intermedia; FIG. 3C). Pond 4 was dominated by chlorophyta (dominant specie of 100%: Pandorina morum; FIG. 3D).

Common algae specie in both WWTW were identified as Pandorina morum. Even though there is no significant reduction or fluctuation of nutrient, this suggests current passive waste water treatment is inadequate, further suggesting that Pandorina morum is inefficient for removal of nutrients. Furthermore, Motetema WWTW holds a greater risk to aquaecology and eco-services in comparison of Leeufontein WWTW; this is due to detection of cyanophyta domination in the final pond of Motetema, where the water is discharged to the Olifants river system (FIG. 3F).

Phytoplankton diversities in the ponds differ with Pandorina morum being dominant in all the ponds. In this finding, no specific trend or distribution pattern of algae is identified in the cascade of ponds. This alga has been described to thrive in summer months and under neutral conditions, but can grow in winter as well. This suggests unstable algal culture in the current passive waste water treatment pond. The abundance of cyanophyta in Motetema ponds suggests potential risks of environmental and aquaecology impacts in comparison to Leeufontein WWTW (FIG. 3F; detection of cyanophyta dominated in the final pond of Motetema, where the water is discharged to the Olifants river system). Thus an urgent need of more effective technology is required to reduce the risk of environmental contamination.

To establish an improved passive treatment pond, one would consider various factors such as:
1. Among those algae species found in a particular territory, which indigenous specie/s is/are most efficient?
2. What are the potential problems to adapt to new effluents?
3. What are the potential risks when algae are released?
4. When are these algae able to assimilate nutrients and what is the turnover rate?
5. How long do the algae require to grow?
6. How much algae is required to start seeing the effect impacting the waste water ponds?
7. Will these axenic algae be able to out-compete the other resident microalgae (especially the algae that have fast growth rates and blue-green algae that produce toxins with low nutrient removal).
8. Will these axenic algae able to thrive under predation (i.e. zooplankton)?
9. Will the release of axenic algae boost/suppress other microbial growth?

Chorella sp. were identified as C. vulgaris and C. prototheocoides and isolated. C. vulgaris and C. protothecoides were known to thrive at similar conditions but at an even higher alkalinity. Chorella sp. were chosen for further nutrient deprivation experiment. This genus of microalgae Chorella has recognized abilities of assimilated nitrogen and phosphorus with different retention times ranging from 10 h to 42 days, in combination of bacteria or absence of bacteria, which shows the potential of replacing activated sludge process in a secondary or tertiary step in view of nutrient reduction and biomass production.

The experiments were designed to address above mentioned questions using C. vulgaris and C. prototheocoides. To do so, axenic cultures of C. vulgaris, C. prototheocoides and the algal combination were implemented 1000 fold less. This is to observe cell counts and cell dominant specie (FIG. 4).

To generate FIG. 4, total cell counts were recorded before and after 7 days of exposure. Samples were examined under microscope to identify the microbe before and after the exposure. Motetema/Leeufontein unfiltered waste water (Control no C. vulgaris/C. prototheocoides been added). C. vulgaris added to Motetema/Leeufontein unfiltered waste water (1:1000 ratio). C. prototheocoides added to Motetema/Leeufontein unfiltered waste water (1:1000 ratio). Combined C. vulgaris and C. prototheocoides added to Motetema/Leeufontein unfiltered waste water (1:1000 ratio). Error bar indicate standard deviation error.

In an exposure experiment, waste water from Pond 6 of Motetema WWTW (FIG. 4A) was exposed to microalgae-scenario 1: C. vulgaris; scenario 2: C. prototheocoides; scenario 3: the algal combination, over periods of 7 days. Total cell counts were recorded after 7 days. Waste water samples exposed to C. vulgaris increased to ˜25× higher relative to day 0 (P=0.266), waste water sample exposed to C. prototheocoides showed an increase to ˜9× higher (P<0.05) and ˜10× higher using combination of algae (P<0.05). In an exposure of waste water from Pond 4 of Leeufontein WWTW (FIG. 4B), cell count ranged from a high for the algal combination with ˜6.25× (P<0.05), then C. prototheocoides with ˜5.5× (P<0.05), then C. vulgaris with ˜1.8× (P<0.05) followed by the control with 1.9× (P=0.315) increase.

These results suggest that all algae are able to grow in both waste waters under the laboratory condition. These algae were also able to out-compete against the indigenous algae found in the ponds. Evidence suggests that growth of algae depends on the types of algae sp. under specific conditions in given media (FIG. 4). In exposure experiments using Motetema waste water, C. vulgaris is less significant in comparison to both C. prototheocoides and combination of algae. In the case of Leeufontein waste water, the combination of algae was more significant than C. prototheocoides and C. vulgaris alone. This suggests that waste water from Leeufontein enhances the growth of the algal combination rather that of one algae species alone.

To obtain an in depth understanding of how the waste water from these 2 sites impacts on the algae growth, microbes from both types of waste water were filtered to minimize the interference of nutrient uptake and algae cell growth. A few parameters were put into consideration viz growth of algae, nutrient assimilation such as N, P, C and S.

To ascertain whether an increase of algae population results in enhanced nutrient removal, 5 categories of nutrient (P, N, C, S and cations) were investigated (FIG.-5).

To generate FIG. 5, no algal cells were introduced to the control experiment. In exposure experiment Motetema waste water were exposed to either C. vulgaris, C. prototheocoides or combination of both cell types with final concentration of 10 000 cells/ml and water were filtered and analysed with following parameters before and after exposure at 0, 3 and 7 days. (A) is algal cell and Chl counts; (B) is total nitrogen and total phosphorous; (C) is nitrogen source; (D) is calcium and magnesium; (E) is total sulphur and dissolved sulphate; and (F) is carbon source. Error bar indicates standard deviation error.

Algal growths in terms of cell counts and chlorophyll of the three different algal sp. exposed to Motetema waste water under laboratory condition were plotted in FIG. 5A. Lag phase was observed in all of the four curves for the first 3 days, thereafter log phase in the next 4 days was present for C. prototheocoides and the combination of algae, whereas the control (Motetema alone; FIG. 5A) and C. vulgaris show no significant increase. Combination of algae proliferates better than C. vulgaris in Motetema waste waters (P<0.05), which coincided with a similarity to C. prototheocoides (FIG. 5), elucidating that both combination of algae and C. protothoecoides will thrive in Motetema waste water.

Chlorophyll (Chl) a and b are naturally occurring pigments in algal cells, and play an important role in photosynthesis by harnessing light. Both chlorophyll a and b contain a central magnesium ion that is encased by a ring structure also known as porphyrin. Chl-a plays an important role in releasing of chemical energy but it is not the only pigment that can be used for the photosynthesis. Chl-b absorbs light energy during photosynthesis, which is more soluble than chl-a in polar solvent. Chl-b is closely associated with photosystem II; under low light intensity, there is an increase ratio of photosystem II to photosystem I, and a low ratio between chl-a to chl-b.

When algae were exposed to the Motetema WWTW, both C. prototheocoides and the algal combination showed a significant increase (P<0.05) of chl-a after day 3 while chl-b remained relatively constant throughout the 7 days exposure window (FIG.-5A). In both cases it was evident that chl-a was the major contributor to the total chl for the photosynthetic event to release chemical energy. Ratios between chl-a and chl-b suggest that C. prototheocoides and the combination of the 2 algae species were driven by photosystem I rather than photosystem II. Production of chl-a is directly proportion to an increase of algal proliferation.

Chl-a also provides valuable information for monitoring different trophic states of rivers and lakes. When Motetema filtered waste water is exposed to combination of algae and C. prototheocoides, this waste water enters the hypertrophic stage at end of day 7, whereas waste water exposed to C. vulgaris enters the eutrophic stage after day 7 (FIG.-5A). This suggest that even though all algae can grow under laboratory conditions in the absence of mechanical aeration, production of chl-a from both the combination of algae and C. prototheocoides is faster than from C. vulgaris alone (FIG.-5A), hence the relationship between the amount of algae is directly proportional to chl-a and the efficiency removal of nutrients.

Phosphorous, (P), is a multivalent none-metal of nitrogen group. In nature P is found in several allostropic forms, and is an essential element for the life of organisms. Phosphorus is a vital component of water ecosystems. In waste water treatment ponds, high concentrations of P can be hazardous to aquatic life if is not properly managed. Discharge of poorly managed waste water from treatment ponds results in an increase of phytoplankton (eutrophication), and a detrimental environmental effect include hypoxia, the depletion of oxygen in the water, which induces reductions in fish and animal population. Domestic sewage is also high in phosphates, with more than 50% of it coming from human waste and 20%-30% from detergents. Animal feedlots are sources of both nitrates and phosphates.

To observe the efficiency of P removal, filtered Motetema waste water was exposed, in the absence of aeration, to C. vulgaris, C. prototheocoides and the algal combination under laboratory conditions. A more profound reduction of P was observed using the algal combination, namely from 3.09 mg/l in day 0 to 2.59 mg/l in day 7 (P<0.05) rather than C. prototheocoides with 3.09 mg/l in day 0 to 1.46 mg/l in day 7 (P<0.05; FIG. 5B.). Interestingly, no reduction of P was found in C. vulgaris after day 7 (mean value: 3.09 mg/l in day 0 to 3.44 mg/l); the effects were adverse and P were enriched in the water column in comparison to Motetema alone (Control: no algae). It has been reported that Chlorella sp. has high removal efficiency (more than 80%) of nutrients in primary and second treatment effluents and, under certain conditions, can completely remove ammonia nitrogen, nitrate, total nitrogen (TN) and total phosphorous (TP). Evidence suggests that C. vulgaris needs to be aerated to have efficient P removal. Therefore, release of C. vulgaris to treat rural waste water may potentially worsen conditions by inducing enrichment of P. This is first evidence to indicate that not all Chlorella sp. are ideally to use to treat passive treatment i.e. C. vulgaris is unable to assimilate P in the absence of aeration.

Besides P, N is the second most important nutrient to microalgae since it may comprise more than 10% of the biomass. In case of N assimilation, N was assimilated by the algal combination ˜C. prototheocoides >C. vulgaris (FIG. 5B). Most efficient algae to consume N were thus the algal combination and C. prototheocoides. To predict which algae will contribute to adopting and inducing “good” eutrophic or hypertrophic levels to reduce nutrient in the water column, a ratio of total nitrogen to total phosphorus (TN/TP) for each alga was investigated (FIG. 5B). The analysis suggests that C. vulgaris, C. prototehocoides alone and the combination of algae were able to reduce the TN:TP ratio over the first 3 days. Notwithstanding discrete and striking changes of appearance, the ratio of TN:TP reduced sharply after day 3 for a period of 4 days, for C. vulgaris and C. prototheocoides alone. This was not the case for the combination of algae (FIG. 4-4B) where the TN:TP ratio, to the contrary, increased after day 3 and TN was more profoundly decreased than TP. From this view, the eutrophication process proceeds from lower to higher tropic states (eutrophic to hypertrophic state) for both individual exposure and combination of algae remains fluctuates between eutrophic and hypertrophic state.

Which N form is preferred by the microalgae was also explored. The source of N in Motetema was mostly composed by ammonium (NH₄⁺) and organic N, where nitrate (NO₃) and nitrite (NO₂⁻) composed minor portion indicated as NOx (FIG. 5C). When filtered Motetema waste water was exposed to C. vulgaris, C. prototheocoides and the combination of 2 algae, a reduction of ammonium, organic N and Total Kjeldahl N (TKN) as well as TN, was experienced, with the greatest reduction being obtained with the algal combination, then C. prototheocoides, then C. vulgaris (FIG. 5C). Among these forms the most common nitrogen compounds assimilated by microalgae are ammonium and organic N. The preferred compound is ammonium, and when this is available, no alternative nitrogen sources will be assimilated. Even though ammonium is preferred by all three algae, ammonium concentrations higher than 20 mg NH₄⁺—N per litre are not recommended due to ammonia toxicity.

Other macronutrients are calcium (Ca) and magnesium (Mg). Ca and Mg play an important role in terms of hardness of water, effect on the algal growth, different types of algae specie and enhanced P removal. Ca is largely responsible for water hardness, and may negatively influence toxicity of other compounds. Metal toxicity influences aquatic organisms by altering hardness of water. Although Ca is required for various structural roles in the cell wall and membranes, it is a counter-cation for inorganic and organic anions in the vacuole, and the cytosolic Ca²⁺ concentration is an obligate intracellular messenger coordinating responses to numerous developmental cues and environmental challenges. No significant Ca assimilation was observed when C. vulgaris, C. prototheocoides and the combined algae were exposed to filtered Motetema waste water (FIG. 5D).

Mg is a mineral that plays an important role in photosynthesis in both algae and the plant kingdom. Mg is a central atom of the chl molecule in releasing of chemical energy and regulates photosystem I and II. In case of Mg assimilation, C. vulgaris assimilated ˜1 mg/l over period of 7 days (P=0.601); C. prototheocoides reduced at ˜1 mg/l over period of 7 days (P=0.068); the algal combination consumed at ˜1.677 mg/l over period of 7 days (P=0.083; FIG. 5D). The amount of Mg depleted from water column is inversely proportional to the increase of Chl-a and total cell counts as indicated in FIG. 5A. This suggests the importance of Mg in the growth of Chlorella sp.

Treatment of Motetema waste water using C. vulgaris, C. prototheocoides and the algal combination may alter water chemistry, potentially induce different algal distribution and alter the dynamics in the pond. Of course, one way is by observing changes of the ratio between Ca:Mg in the water column. In the case of the Ca:Mg ratio, in the event of Ca:Mg greater or equal to 4:1 there is potential to induce green filamentous algae development, and consequently holds the risk of clogging the waste water treatment. In all three cases of algal exposure, the ratio between Ca:Mg shows no statistical significant difference over the period of 7 days. This suggests that neither exposure of Chlorella sp. alone nor combined algae are capable of inducing growth of filamentous algae.

Sulphur plays an important role in cellular process in algae and promote algal growth. In the event of algal exposure, total S did not show statistical significance in reduction under laboratory conditions. In the case of SO₄²⁻) only the algal combination showed a reduction of 3.67 mg/l (P=0.078) over period of 7 days (FIG. 5E). However, C. vulgaris and C. prototheocoides alone did not show any statistical significant reduction of SO₄²⁻. A possible explanation is that a balance between nitrate and SO₄²⁻reduction is required; the availability of nitrogen compounds could influence the SO₄²⁻reduction sequence and vice versa, enhancing possible signals for the regulation of the SO₄²⁻ reduction pathway. In the light of the results obtained with the combined algae, the way to assimilate SO₄²⁻ is hence when TN assimilation is at its optimum (FIG. 5C).

Photosynthesis requires inorganic carbon to assimilate in microalgae. These inorganic carbon species, such as CO₂ and HCO₃⁻, are commonly used by microalgae, and the latter requires the enzyme carbonic anhydrase to convert it to CO₂. Nonetheless, there are algal species that are able to metabolise organic carbon sources as well, such as organic acids, sugars, acetate or glycerol and this process is also known as heterotrophic metabolism. In the waste water ponds, these nutrients are considerable loads, where the standing crops of algae can be very high and consequently exhaust the carbon dioxide.

In Motetema, the amount of HCO₃⁻ assimilated by the algal combination were 1 721.07 mmol/l (P<0.05); by C. prototheocoides were 1 189.47 mmol/l; P=0.072 and by C. vulgaris were 397.95 mmol/l with no statistical significance, under laboratory condition (FIG. 5F). This suggests involved inorganic carbon assimilation was driven by both the algal combination and C. prototheocoides alone, efficiently in comparison to C. vulgaris. Even though C. vulgaris was unable to metabolise inorganic biscarbonate significantly, alternative carbon source such as organic carbon were utilized by C. vulgaris in earlier reports. C. vulgaris is most commonly used in the treatment of waste water ponds and the mode of carbon nutrition can be shifted from autotrophy to heterotrophy when the carbon source is changed. The amount of CO₂ dissolved in waste water depends on pH, with the relationship between CO₂ being inversely proportion to the pH. In the literature, at a pH greater than 9, most of the inorganic carbon is in form of CO₃²⁻ which cannot be assimilated by the algae. This phenomenon was also found when waste water exposed to these algae indicated a direct proportion between CO₃²⁻ to pH, with an increase of pH resulting in increase in CO₃²⁻ (FIG. 5F). Although there is literature supported this finding, this effect is not pronounced (statistical significance).

To generate FIG. 6, no algal cells were introduced to the control experiment. In exposure experiment Leeufontein waste water were exposed to either C. vulgaris, C. prototheocoides or combination of both cell types with total cell density of 10 000 cells/ml and water were filtered and analysed with following parameters before and after exposure at 0, 3 and 7 days. (A) is algal cell and Chl counts; (B) is total nitrogen and total phosphorous; (C) is nitrogen source; (D) is calcium and magnesium; (E) is total sulphur and dissolved sulphate; and (F) is carbon source. Error bar indicates standard deviation error.

Leeufontein waste water works have been described as less than 80% compliant with the Green Drop water certification. The obtained cell counts and chlorophyll estimations (FIG. 6A) indicate that there is an increase in microbial biomass over 7 days in water samples where algae were added. This increase is steeper than in the case where C. protothecoides alone was added to the effluent sample (P<0.05). Biomass increase was accelerated after day 3 in this sample, as well as in the combination of C. protothecoides and C. vulgaris (P<0.05). The algae C. protothecoides alone proliferated best in the Leeufontein waste water sample.

This is evident in a greater cell count increase compared to either C. vulgaris or the combination of both algae. In addition, chl concentrations were highest in the treatment with C. protothecoides alone (P<0.05), indicating that algal biomass had indeed increased. Chl is generally used as an algal quantification method, particularly chl-a. Chlorophyll levels increased more noticeably from day 3 in all the samples, although C. vulgaris did not show a great increase in biomass or chl concentrations compared to the other two samples. Chl acts a confirmation of the biomass increase as it has been found to be proportional to algal and bacterial growth. In addition, other aspects of the water chemistry were analysed.

The water chemistry of a number of key components for algal growth were analysed after removal of algae by filtration. P, N and C have been postulated to be the three main components required for algal proliferation.

In order to determine whether the increase in biomass was effective in depleting nutrients within the waste water effluent, phosphate and nitrate concentration were monitored alongside the algal biomass increase. The water chemistry was monitored at same time intervals as the biomass and chl concentrations (FIG. 6A), after removal of algae through filtration. Based on the findings (FIG. 6B), C. protothecoides was efficient in the removal of P (2.83 mg/l; P<0.05) and N (8.77 mg/l; P<0.05) from the effluent sample. The TN:TP ratio increased (P=0.08) from day 3 as phosphorous levels decreased faster than nitrogen levels in the effluent simultaneously with algal biomass increase. TN:TP ratios have been described to fluctuate seasonally and high nitrogen levels have been traced to anthropogenic sources. With that being said, it is not surprising that nitrogen level was visibly higher than phosphorous levels in this sample. Nitrogen is essential for a variety of enzyme and cellular functions within the algal cell and is enhanced in microalgae, which makes them advantageous for the removal of nitrogen in waste water. However, the algal combination and C. protothecoides samples are effective in the removal of both phosphorous (3.85 mg/l; P<0.05) and nitrogen (7.70 mg/l; P<0.05). Phosphorous depletion is an essential part in algal nutrition, which explains the depletion of phosphorous levels in the effluents.

Phosphorous is essential in the conversion of light to biochemical energy in photosynthesis by plants and algal samples and increased algal growth is directly related to phosphorous depletion in aqueous samples. Furthermore, the phosphorous uptake is not only for nutritional benefits, as Chlorella has been found to have a greater phosphorous intake capacity beyond nutritional needs. C. vulgaris alone did not effectively remove TP but reduced TN levels.

Nitrogen was further divided into different categories (FIG. 6C). In these samples, total nitrogen decreases over time although there appear to be fluctuations in the different forms of N over the 7 day period. Algal uptake appears to be through organic nitrogen and nitrate, since these are the forms of nitrogen appearing to be depleted over time. Again, the depletion is most evident in both the algal combination (TN: 7.70 mg/l with P<0.01; TKN: 7.67 mg/l with P<0.01; and NH₄: 6.90 mg/l with P<0.05) and the C. protothecoides sample (TN: 8.77 mg/l with P<0.01; TKN: 8.67 mg/l with P<0.01; and NH₄: 7.30 mg/l with P<0.01). However, C. protothecoides showed the highest biomass increase and chlorophyll concentrations (FIG. 4-5A). The uptake of ammonia and nitrate has been explained and is expected in phytoplankton growth.

The depletion of calcium and magnesium levels after algal culture is expected as algae require these elements for metabolic processes (FIG. 6D). Based on the graph, it is clear that C. protothecoides (Mg: 8.33 mg/l with P<0.01) and the algal combination (Mg: 7 mg/l with P<0.01) grew better than C. vulgaris as the magnesium levels are least reduced in C. vulgaris (Mg: 2.33 mg/l with P=0.155). This supports the findings in (FIG. 6A and FIG. 6B), as metabolic activity is evidence that the algal species were indeed proliferating in the water effluent sample. No Ca assimilation were observed when C. vulgaris, C. prototheocoides and the algal combination were exposed to filtered Leeufontein waste water (FIG. 6D). Chlorella has been found to be tolerant to high levels of magnesium and the presence of calcium does not decrease the toxicity of high magnesium levels. The progression in the Ca:Mg ratio after exposure of the waste water to these algae, is noteworthy. This suggests that exposure of Chlorella sp. alone or combined algae for long term may induce growth of filamentous algae in long run in Leeufontein.

There appeared to be no effect (no statistical significance) on total sulphur content from algal proliferation (FIG. 6E), meaning that the algae did not act in the removal of sulphur within the water effluent, as the trend in the algal samples is identical to that of the control. However, sulphate was reduced by the algal combination (SO₄: 4.33 mg/l with P<0.05) and C. protothecoides (SO₄: 3.00 mg/l with no significant difference). Sulphur is essential in the metabolism of metals and microbial oxidation reactions; however it appears that the algae in this study are not particular sulphur oxidizers or reducers in terms of niche, although sulphur is required, it is not the main constituent required for growth.

Finally, the carbonate component of the water chemistry was analysed, along with the pH that was monitored. The increased alkalinity of the water samples with algae (FIG. 6F) is indicative of photosynthesis occurring. The pH increased significantly from around 7 to around 9.5 in samples with the algal combination (P<0.01) and in C. protothecoides (P<0.01) where higher biomass and chlorophyll concentrations were observed. The increased CO₃ and pH are due to the shift in CO₂ from photosynthesis. Already, this indicates that the microalgae can produce niche conditions that eliminate competition with most mesophillic microbes through photosynthesis. This is through the increased alkalinity produced during photosynthesis. This is ideal as these algae thrive under alkaline conditions, with pH ranges of 12-13. In Leeufontein, the amount of HCO₃⁻ assimilated by the algal combination were 971.53 mmol/l (P<0.01); by C. prototheocoides were 1 033.89 mmol/l with P<0.01 and by C. vulgaris 112.5 mmol/l with P<0.01, under laboratory condition (FIG. 4-5F). This suggests that involved inorganic carbon assimilation were driven by both the algal combination and C. prototheocoides alone efficiently in comparison to C. vulgaris alone.

Combining the findings from all the elements of the water chemistry of Leeufontein it is clear that C. protothecoides and the combined algae samples are effective in the removal of phosphates and nitrates within the samples and this is directly related to the algal growth patterns. There appears to be an increased TN:TP ratio at the end of Day 7 which may indicate that the imbalance will reflect in the algal growth. In addition, the increase in pH over time indicates that the algae may proliferate abundantly, thus requiring their removal or there may be a shortage of nutrients over time within the water sample as nutrient levels may result in a bottleneck effect.

The results are also given in Table 4.

TABLE 4
The characteristics of filtered treated waste water with microalgae

| | Motetema | | | | Leeufontein | | | |
|---|---|---|---|---|---|---|---|---|
| | | | | Motetema + C. | | | | Leeufontein + |
| | Motetema | Motetema + | Motetema + C. | vulgaris + C. | Leeufontein | Leeufontein + | Leeufontein + C. | C. vulgaris + C. |
| Study site | (Control) | C. vulgaris | prototheocoides | prototheocoides | (Control) | C. vulgaris | prototheocoides | prototheocoides |

Nutrient decrease/growth rate per day

| | | | | | | | | |
|---|---|---|---|---|---|---|---|---|
| Cell counts/ | 7.81E+03 | 1.67E+04 | 1.86E+05 | 2.13E+05 | 4.76E+02 | 1.01E+05 | 4.74E+05 | 3.22E+05 |
| Day | | | | | | | | |
| Chl-a (μg/ml)/ | B/D | 0.11 | 0.71 | 0.69 | 0.04 | 0.30 | 0.89 | 1.15 |
| Day | | | | | | | | |
| Chl-b (μg/ml)/ | 1.44 | 1.38 | 1.29 | 1.36 | −0.07 | 0.03 | 0.10 | 0.22 |
| Day | | | | | | | | |
| Chl (μg/ml)/ | 2.53 | 2.49 | 2.54 | 2.61 | −0.02 | 0.33 | 1.25 | 1.10 |
| Day | | | | | | | | |
| TP (mg/L)/Day | −0.02 | 0.05 | −0.08 | −0.23 | N/D | 0.08 | −0.40 | −0.55 |
| TN (mg/L)/Day | −0.43 | −0.48 | −1.10 | −2.95 | −0.48 | −1.40 | −1.25 | −1.10 |
| NH₄ (mg/L)/ | −0.24 | −0.48 | −1.43 | −1.38 | 0.05 | −0.14 | −1.04 | −0.99 |
| Day | | | | | | | | |
| pH | 0.00 | 0.01 | 0.07 | 0.08 | 0.07 | 0.07 | 0.20 | 0.20 |
| HCO₃ (mg/L)/ | −14.39 | −56.85 | −169.92 | −245.87 | −6.74 | −16.08 | −147.70 | −138.79 |
| Day | | | | | | | | |
| SO₄ (mg/L)/ | −0.05 | −0.24 | −0.43 | −0.52 | 0.05 | −0.05 | −0.43 | −0.62 |
| Day | | | | | | | | |

Percentage of Nutrient remove (%)

| | | | | | | | | |
|---|---|---|---|---|---|---|---|---|
| TP | 5.32 | −10.96 | 17.23 | 52.35 | N/A | −12.04 | 62.78 | 64.44 |
| TN | 9.18 | 11.49 | 26.42 | 51.64 | 11.17 | 28.50 | 30.76 | 28.10 |
| NH₄ | 6.33 | 12.82 | 37.04 | 37.18 | −2.22 | 6.67 | 48.67 | 46.00 |
| HCO₃ | 3.77 | 14.91 | 44.56 | 64.47 | 2.10 | 5.01 | 45.97 | 43.20 |
| SO₄ | 0.67 | 3.33 | 6.00 | 7.48 | −0.21 | 0.21 | 1.89 | 2.74 |

Days required to get to 0%

| | | | | | | | | |
|---|---|---|---|---|---|---|---|---|
| TP | 131.66 | N/A | 40.64 | 13.37 | N/A | N/A | 11.15 | 10.86 |
| TN | 76.26 | 60.94 | 26.50 | 13.56 | 626.47 | 24.56 | 22.76 | 24.91 |
| NH₄ | 110.60 | 54.60 | 18.90 | 18.83 | N/A | 104.97 | 14.38 | 15.22 |
| HCO₃ | 185.56 | 46.96 | 15.71 | 10.86 | 3336.40 | 139.85 | 16.20 | 15.23 |
| SO₄ | 1043.42 | 210.00 | 116.66 | 93.55 | N/A | 3319.33 | 370.98 | 255.25 |

N/D No difference
B/D Below detection limit
N/A Not applicable

In summary, characteristics of the filtered waste water experiment are as follows:

Exposure to C. vulgaris

C. vulgaris proliferation and chl production within seven days was 16 700 cells/ml/day and 0.11 μg/ml chl-a/day and chl-b remains unchanged (no statistical significance) for Motetema; 101 000 cells/ml/day and 0.30 μg/ml chl-a/day for Leeufontein and chl-b remains unchanged (no statistical significance). Total chl were incremented at 2.49 μg/ml/day for Motetema and 0.33 μg/ml/day for Leeufontein. TP was enriched at rate of 0.05 mg/l/day for Motetema and 0.08 mg/l/day for Leeufontein. The rate of removal of TN at 0.48 mg/l/day for Motetema and 1.4 mg/l/day for Leeufontein. Rate of NH₄ removal in Motetema was at 0.48 mg/l/day and 0.14 mg/l/day for Leeufontein. pH increment at a rate of 0.01 per day for Motetema and 0.07 per day for Leeufontein. Assimilation of HCO₃ was at a rate of 56.85 mg/l/day for Motetema and 16.68 mg/l/day for Leeufontein. Removal of SO₄ was at a rate of 0.24 mg/l/day for Motetema and 0.05 mg/l/day for Leeufontein.

The removal percentage of TN after day 7 was approximately 11.49 (Motetema) and 28.50% (Leeufontein); TP increased by 10.96% (Motetema) and 12.04% (Leeufontein) respectively. Percentage of NH₄ assimilation after 7 days was approximately 12.82% for Motetema and 6.67% for Leeufontein respectively. Percentage of HCO₃ assimilation after 7 days was approximately 14.91% for Motetema and 5.01% for Leeufontein respectively. Percentage of SO₄ assimilation after 7 days was approximately 3.33% for Motetema and 0.21% for Leeufontein respectively.

The estimated time for the complete removal of TN was 60.94 days for Motetema and 24.56 days for Leeufontein. It was concluded that C. vulgaris was unable to remove TP for waste water acquired from both sites. The estimated time for the complete removal of NH₄ was 54.60 days for Motetema and 104.97 days for Leeufontein. The estimated time for the complete removal of HCO₃ was 46.96 days for Motetema and 139.85 days for Leeufontein. The estimated time for the complete removal of SO₄ was 210 days for Motetema and 3 319.33 days for Leeufontein.

Exposure to C. prototheocoides

C. prototheocoides cultures started from a cell density of 10 000 cells/ml and where was a significant increase in algal growth within first 7 days (P<0.05). The algal proliferation and chlorophyll production within seven days was 186 000 cells/ml/day and 1.29 μg/ml chl-a/day for Motetema; 474 000 cells/ml/day and 0.10 μg/ml chl-a/day for Leeufontein. Total chl were incremented at 2.54 μg/ml/day for Motetema and 1.25 μg/ml/day for Leeufontein. TP was reduced at rate of 0.08 mg/l/day for Motetema and 0.40 mg/l/day for Leeufontein. Whereas the rate of removal of TN at 1.10 mg/l/day for Motetema and 1.25 mg/l/day for Leeufontein. Rate of NH₄ removal in Motetema is at 1.43 mg/l/day and 1.04 mg/l/day for Leeufontein. pH increment at rate of 0.07 per day for Motetema and 0.20 per day for Leeufontein. Assimilation of HCO₃ was at rate of 169.92 mg/l/day for Motetema and 147.7 mg/l/day for Leeufontein. Removal of SO₄ was at rate of 0.43 mg/l/day for Motetema and 0.43 mg/l/day for Leeufontein.

The removal percentage of TN by C. prototheocoides after day 7 was approximately 26.42% for Motetema and 30.76% for Leeufontein; TP decreased by 17.23% for Motetema and 62.78% for Leeufontein respectively. Percentage of NH₄ assimilation after 7 days was approximately 37.04% for Motetema and 48.67% for Leeufontein respectively. Percentage of HCO₃ assimilation after 7 days was approximately 44.56% for Motetema and 45.97 for Leeufontein respectively. Percentage of SO₄ assimilation after 7 days was approximately 6% for Motetema and 1.89% for Leeufontein respectively.

The estimated time for the complete removal of TN was 26.50 days for Motetema and 22.76 days for Leeufontein. Time required to remove TP by C. prototheocoides was 40.64 days for Motetema and 11.15 days for Leeufontein. The estimated time for the complete removal of NH₄ was 18.90 days for Motetema and 14.38 days for Leeufontein. The estimated time for the complete removal of HCO₃ was 15.71 days for Motetema and 16.20 days for Leeufontein. The estimated time for the complete removal of SO₄ was 116.66 days for Motetema and 370.98 days for Leeufontein.

### Exposure to the Algal Combination

In a series of algae combinations starting from 5 000 cells/ml of C. vulgaris and 5 000 cells/ml of C. prototheocoides with final biomass density (10 000 cells/nil), there was a significant increase in algal growth within the first 7 days (P<0.05). The algal proliferation and chlorophyll production within seven days was 213 000 cells/ml/day and 0.69 μg/ml chl-a/day for Motetema and 322 000 cells/ml/day and 1.15 μg/ml chl-a/day for Leeufontein. Total chl were incremented at 2.61 μg/ml/day for Motetema and 1.10 μg/ml/day for Leeufontein. TP was reduced at rate of 0.23 mg/l/day for Motetema and 0.55 mg/l/day for Leeufontein. Whereas the rate of removal of TN at 2.95 mg/l/day for Motetema and 1.10 mg/l/day for Leeufontein. Rate of NH₄ removal in Motetema is at 1.38 mg/l/day and 0.99 mg/l/day for Leeufontein. pH increment at rate of 0.08 per day for Motetema and 0.20 per day for Leeufontein. Assimilation of HCO₃ was at rate of 245.87 mg/l/day for Motetema and 138.79 mg/l/day for Leeufontein. Removal of SO₄ was at rate of 0.52 mg/l/day for Motetema and 0.62 mg/l/day for Leeufontein

The removal percentage of TN by combination of algae after day 7 was approximately 51.64% for Motetema and 28.10% for Leeufontein; TP decreased by 52.35% for Motetema and 64.44% for Leeufontein respectively. Percentage of NH₄ assimilation after 7 days was approximately 37.18% for Motetema and 46% for Leeufontein respectively. Percentage of HCO₃ assimilation after 7 days was approximately 64.47% for Motetema and 43.20 for Leeufontein respectively. Percentage of SO₄ assimilation after 7 days was approximately 7.48% for Motetema and 2.74% for Leeufontein respectively.

The estimated time for the complete removal of TN was 13.56 days for Motetema and 24.91 days for Leeufontein. Time required to remove TP by combination of algae was 13.37 days for Motetema and 10.86 days for Leeufontein. The estimated time for the complete removal of NH₄ was 18.83 days for Motetema and 15.22 days for Leeufontein. The estimated time for the complete removal of HCO₃ was 10.86 days for Motetema and 15.23 days for Leeufontein. The estimated time for the complete removal of SO₄ was 93.55 days for Motetema and 255.25 days for Leeufontein.

The chemical compositions of the two waste water ponds are listed in Table 3. In the case of C. vulgaris exposure the chemical characteristics of the waste waters did change but not as significantly as for the algal combination and C. prototheocoides alone. The exposed effluent by C. prototheocoides and the algal combination were able to minimize TN, TP, NH₄+ and HCO₃²⁻ significantly over a period of 7 days (Table 4). However, only combined algae treatment to these effluents were able to remove the chemical over a shorter time window relatively to the C. prototheocoides alone.

It is thus concluded that though C. vulgaris is unable to remove nutrients in the absence of mechanical aeration, both C. prototheocoides and the combination of C. vulgaris and C. prototheocoides has the potential to be incorporated into a program of saturated waste water treatment ponds for nutrients (N and P) polishing since only a short period (3-7 days) is required for the algal development to reach its full growth. However, harvesting algae or control of proliferation of algae is necessary. Therefore, the last stage of the primary saturating pond is by introducing zooplankton to remove algae.

An algal combination of C. vulgaris and C. prototheocoides diminish both TN and TP more efficiently than C. prototheocoides alone in a shorter period of time, which can be applied at different rural saturating pond (absence of mechanical aeration). Furthermore, it is concluded that C. vulgaris alone is not an ideal algal specie to remove P from these sites, but rather enriched P content in the water column.

It has now been shown that in the absence of electrical-powered mechanical aeration, C. vulgaris has no effect on the phosphorous removals, even though C. vulgaris is able to grow in these effluents under laboratory condition. On the other hand, C. prototheocoides is able to remove P more efficiently then C. vulgaris alone. However, in an algal combination of the 2 microalgae, amounts of P removal shows no significant difference to C. prothotheocoides alone but the rate of efficiency improved by reducing time required to remove P. The trend of P assimilation behaviour applies to both WWTWs under laboratory condition.

Leeufontein is a water treatment system that is composed of four treatment ponds. It is thus proposed to introduce algal treatment as a final polishing step after Pond 2 (FIG. 1). As set out above, there is inefficiency in existing waste water treatment to reduce nutrients. The water from the secondary treatment pond (see FIG. 1) is released into the environment and poses a health risk as it is not up to standard for potable water. Algal remediation is a natural, passive and thus energy efficient approach to enhancing water quality.

In case of N up take, it depends on both composition and the conditions of effluents that plays an very important roles in algal-based remediation. In the combination of micoalgae scenario, the efficiency of N uptake in comparison to C. prototheocoides was not as significant in the Leeufontein waste water works. However it was significant in comparison to C. vulgaris alone. However, N assimilation was not significantly different between the algal combination and C. prothotheocoides at different site.

In the case of Leeufontein, C. protothecoides or the algal combination was most effective in the removal of nutrients in the water effluent. Based on time factor and efficient removal of nutrients (Table 4) these two algal samples or components were chosen as the effective treatment options. The algal combination was effective as was C. prototheocoides alone; however C. vulgaris was only effective within the algal combination and showed limited nutrient removal overall compared to the other samples. It was not effective in the removal of P and not as efficient in the removal of other nutrients as well. The algal proliferation was found to be related to the biomass, chl concentrations as well as a shift in the water chemistry of the effluent.

There was a reduction of P, N and C within the water samples, with an increase in the alkalinity, indicating photosynthesis. These factors prove on a small scale that the algal treatment could officially work when implemented on a larger scale.

### REFERENCES

Clescerl L S, Greenberg A E, Eaton A D, (1998) Standard Methods for the examination of water and waste water 20th Edition. 4500—Norg B. Macro-Kjeldahl Method. 4500-NH3 C. Titrimetric Method.
Davis J C, 1973. Statistics and data analysis in geology, John Wiley Sons, inc., New York, 550p
DWA, Department of Water Affairs, South Africa 2012. Green Drop Progress Report. Chapter 9. pp 268-290
EPA, U.S. Environmental Protection Agency 2002. Methods for Measuring the Acute Toxicity of Effluents and Receiving Waters to Freshwater and Marine Organisms. EPA-821-R-02-012. 5^{th} edition
EPA, U.S. Environmental Protection Agency 1983. Methods for Chemical Analysis of Water and Wastes, EPA-600/4-79-020. Method 325.2.
Kjeldahl J. 1883 A new method for the determination of nitrogen in organic matter. Z Anal Chem 2:366
Pitwell, L R. 1983 Standard COD. Che, Brit. 19:907
Porra, R J, Thompson, W A, Kriedemann, P E, 1989. Determination of accurate extinction coefficient and simultaneous equations for assaying chlorophylls a and b extracted with four different solvents: verification of the concentration of chlorophyll standards by atomic absorption spectrometry. Biochimica et Biophysica Acta 975: 384-394.
Zeiger, E, Taiz, L. 2006. Ch. 7: Topic 7.11: Chlorophyll Biosynthesis. Plant physiology (4th ed.). Sunderland, Mass.: Sinauer Associates.

1. A biological process for treating waste water, which process includes
introducing an algal component into the waste water, wherein the algal component comprises Chlorella prototheocoides or a combination of Chlorella prototheocoides and Chlorella vulgaris; and
while maintaining passive conditions in the waste water, allowing the algal component to extract at least one nutrient from the waste water, thereby to phycoremediate the waste water.

2. The biological process according to claim 1, which is a continuous process.

3. The biological process according to claim 1, wherein the waste water is sewage, with the sewage being phycoremediated by removing magnesium, calcium, sulphur, carbon, cations, phosphorus and/or nitrogen therefrom by means of biosorption.

4. The biological process according to claim 3, wherein the algal component is introduced into the waste water downstream of at least one other water treatment stage.

5. The biological process according to claim 4, wherein the other water treatment stage is a primary treatment stage, with process including first subjecting the sewage to primary treatment, in the primary treatment stage, to remove metals present therein.

6. The biological process according to claim 5, wherein the primary treatment stage comprises a first pond having a depth of 2-5 metres.

7. The biological process according to claim 6, wherein the effluent from the first pond is subjected to secondary treatment to reduce the ammonia loading of the sewage, with the secondary treatment comprising passing the first pond effluent into a second pond, where digestion of organic material in the effluent takes place.

8. The biological process according to claim 7, wherein the effluent from the second pond is subjected to the treatment thereof with the algal component, with this treatment constituting tertiary treatment and the tertiary treatment being effected in a third pond

9. The biological process according to claim 8, wherein the third pond is 0.5 to 1 m deep, and provides a body of water comprising the second pond effluent, and in which the nutrient removal from the sewage by means of the phycoremediation is effected, while maintaining passive conditions in the third pond.

10. The biological process according claim 8, wherein sufficient of the algal component is introduced into the third pond initially so that the proportion of algal component cells or cultured cells, to other natural occurring algal cells, in the waste water is in a ratio of about 1 (cultured algal cell):1000 (natural occurring algal cells).

11. The biological process according to claim 10 wherein, when the algal component comprises the combination of Chlorella prototheocoides and Chlorella vulgaris, the cellular ratio of the two algal species is about 1:1.

12. The biological process according to claim 10, wherein the sewage residence time in the third pond is at least 7 days.

13. The biological process according to claim 8, wherein sufficient of the algal component is used so that the total concentration of the algal cells in the sewage is at least 10 000 cells/ml initially.

14. The biological process according to claim 8, which is characterized thereby that no mechanical agitation or aeration is effected in the third pond.

15. The biological process according to according to claim 9, wherein the entire process is a passive treatment process, in which no mechanical agitation or aeration is effected in any of the ponds.

16. The biological process according to claim 8, wherein effluent is withdrawn from the third pond, with this effluent being subjected to further treatment for algal removal, thereby to control algal proliferation.

17. The biological process according to claim 16, wherein the further treatment is effected in a fourth pond, in which the effluent is subjected to algae removal by means of zooplankton.

18. The biological process according to claim 17, wherein the waste water residence time in the fourth pond is in the region of 9 to 15 days.
